(19) United States
(12) Patent Application Publication
(10) Pub. No.: US 2016/0344815 A1
(43) Pub. Date: Nov. 24, 2016

(54) APPARATUS AND METHOD FOR CONTROLLING EXTERNAL DEVICE

(71) Applicant: Samsung Electronics Co., Ltd., Gyeonggi-do (KR)

(72) Inventors: Eun Jung HYUN, Seoul (KR); Suyoung PARK, Gyeonggi-do (KR); Jin Hong JEONG, Gyeonggi-do (KR); Ji-Hyun PARK, Gyeonggi-do (KR)

(21) Appl. No.: 15/158,870

(22) Filed: May 19, 2016

(30) Foreign Application Priority Data
May 22, 2015 (KR) 10-2015-0072059

(51) Int. Cl. H04L 29/08; H04L 12/24

(52) U.S. Cl. CPC H04L 67/125; H04L 67/18; H04L 41/082

(57) ABSTRACT

An electronic device comprising: a memory; and at least one processor operatively coupled to the memory, configured to: identify a first device group including at least a first external device; select an operating mode; retrieve, from the memory, setting information associated with the operating mode; generate converted setting information that corresponds to the first device group based on the setting information; and control the first external device based on at least some of the converted setting information.

### CLAIM OF PRIORITY

This application claims the priority under 35 U.S.C. §119(a) to Korean Application Serial No. 10-2015-0072059, which was filed in the Korean Intellectual Property Office on May 22, 2015, the entire content of which is hereby incorporated by reference.

### TECHNICAL FIELD

The present disclosure relates to electronic devices in general, and more particularly, to an apparatus and method for controlling an external device.

### BACKGROUND

The Internet is connected to by a number of computing devices such as servers, personal computers, mobile devices, and enables the exchange of information between such devices. Recently, many attempts for exchanging various pieces of information or data have been made by connecting things (for example, sensors, electronics devices, meters, etc.) that do not have computing capabilities in general as well as computing devices to the Internet. As such, a mechanism for connecting things to the Internet is generally referred to as the Internet of Things (IoT).

In the Internet of Things, a lot of research and developments have been made to establish a protocol for communicating with various devices, communication between devices, the collection of data, and the like. It is expected that the Internet of Things will be combined with various conventional technologies so as to contribute to technical development over the Internet.

### SUMMARY

For the implementation of the Internet of Things, various types of Internet of Things (IoT) can be connected to the Internet. However, the user has difficulty in learning about various IoT devices provided in various environments (for example, home, office, hotel, etc.) due to the diversity in computing capability, communication means, a platform, a user interface or the like that various IoT devices have.

Various embodiments of the present disclosure may provide an apparatus and method for controlling various IoT devices in various environments so as to correspond to an environment that a user prefers.

According to aspects of the disclosure, an electronic device is provided comprising: a memory; and at least one processor operatively coupled to the memory, configured to: identify a first device group including at least a first external device; select an operating mode; retrieve, from the memory, setting information associated with the operating mode; generate converted setting information that corresponds to the first device group based on the setting information; and control the first external device based on at least some of the converted setting information.

According to aspects of the disclosure, a method is provided for use in an electronic device, comprising: identifying a first device group including at least a first external device; selecting an operating mode; retrieving, from a memory, setting information associated with the operating mode; generating converted setting information that corresponds to the first device group based on the setting information; and controlling the first external device based on at least some of the converted setting information.

According to aspects of the disclosure, a non-transitory computer readable medium is provided that stores one or more processor-executable instructions which when executed by at least one processor cause the at least one processor to execute a method comprising the steps of: identifying a first device group including at least a first external device; selecting an operating mode; retrieving, from a memory, setting information associated with the operating mode; generating converted setting information that corresponds to the first device group based on the setting information; and controlling the first external device based on at least some of the converted setting information.

### BRIEF DESCRIPTION OF THE DRAWINGS

FIG. 1 is a diagram of an example of a system for controlling an IoT device, according to various embodiments of the present disclosure;

FIG. 2 is a diagram of an example of a network environment, according to various embodiments of the present disclosure;

FIG. 3 is a diagram of an example of an electronic device, according to various embodiments of the present disclosure;

FIG. 4 is a diagram of an example of a program module, according to various embodiments of the present disclosure;

FIG. 5 is a diagram of an example of a device management module, according to various embodiments of the present disclosure;

FIG. 6A is a diagram illustrating an example of a technique for determining setting information, according to various embodiments of the present disclosure;

FIG. 6B is a diagram illustrating an example of a technique for determining setting information, according to various embodiments of the present disclosure;

FIG. 7A is a diagram illustrating an example of a technique for updating setting information, according to various embodiments of the present disclosure;

FIG. 7B is a diagram illustrating an example of a technique for updating setting information, according to various embodiments of the present disclosure;

FIG. 8 is a flowchart of an example of a process, according to various embodiments of the present disclosure;

FIG. 9 is a flowchart of an example of a sub-process associated with the process of FIG. 8, according to various embodiments of the present disclosure;

FIG. 10 is a sequence diagram of an example of a process, according to various embodiments of the present disclosure;

FIG. 11 is a flowchart of an example of a process, according to various embodiments of the present disclosure;

FIG. 12 is a flowchart of an example of a sub-process associated with the process of FIG. 11, according to various embodiments of the present disclosure;

FIG. 13 is a flowchart of an example of a sub-process associated with the process of FIG. 11, according to various embodiments of the present disclosure;

FIG. 14 is a flowchart of an example of a process, according to various embodiments of the present disclosure;

FIG. 15 is a flowchart of an example of a process, according to various embodiments of the present disclosure;

FIG. 16 is a sequence diagram of an example of a process, according to various embodiments of the present disclosure;

FIG. 17 is a flowchart of an example of a process, according to various embodiments of the present disclosure;

FIG. 18 is a flowchart of an example of a process, according to various embodiments of the present disclosure;

FIG. 19 is a flowchart of an example of a process, according to various embodiments of the present disclosure; and

FIG. 20 is a sequence diagram of an example of a process, according to various embodiments of the present disclosure.

### DETAILED DESCRIPTION

Hereinafter, various embodiments of the present disclosure will be described with reference to the accompanying drawings. In the following description, specific details such as detailed configuration and components are merely provided to assist the overall understanding of these embodiments of the present disclosure. Therefore, it should be apparent to those skilled in the art that various changes and modifications of the embodiments described herein can be made without departing from the scope and spirit of the present disclosure. In addition, descriptions of well-known functions and constructions are omitted for clarity and conciseness.

The present disclosure may have various embodiments, and modifications and changes may be made therein. Therefore, the present disclosure will be described in detail with reference to particular embodiments shown in the accompanying drawings. However, it should be understood that the present disclosure is not limited to the particular embodiments, but includes all modifications/changes, equivalents, and/or alternatives falling within the spirit and the scope of the present disclosure. In describing the drawings, similar reference numerals may be used to designate similar elements.

The terms “have”, “may have”, “include”, or “may include” used in the various embodiments of the present disclosure indicate the presence of disclosed corresponding functions, operations, elements, and the like, and do not limit additional one or more functions, operations, elements, and the like.

The terms “A or B”, “at least one of A or/and B” or “one or more of A or/and B” used in the various embodiments of the present disclosure include any and all combinations of words enumerated with it. For example, “A or B”, “at least one of A and B” or “at least one of A or B” means (1) including at least one A, (2) including at least one B, or (3) including both at least one A and at least one B.

Although the term such as “first” and “second” used in various embodiments of the present disclosure may modify various elements of various embodiments, these terms do not limit the corresponding elements. For example, these terms do not limit an order and/or importance of the corresponding elements. These terms may be used for the purpose of distinguishing one element from another element. For example, a first user device and a second user device all indicate user devices and may indicate different user devices. For example, a first element may be named a second element without departing from the scope of right of various embodiments of the present disclosure, and similarly, a second element may be named a first element.

It will be understood that when an element (e.g., first element) is “connected to” or “(operatively or communicatively) coupled with/to” to another element (e.g., second element), the element may be directly connected or coupled to another element, and there may be an intervening element (e.g., third element) between the element and another element. To the contrary, it will be understood that when an element (e.g., first element) is “directly connected” or “directly coupled” to another element (e.g., second element), there is no intervening element (e.g., third element) between the element and another element.

The expression “configured to (or set to)” used in various embodiments of the present disclosure may be replaced with “suitable for”, “having the capacity to”, “designed to”, “adapted to”, “made to”, or “capable of” according to a situation. The term “configured to (set to)” does not necessarily mean “specifically designed to” in a hardware level. Instead, the expression “apparatus configured to . . . ” may mean that the apparatus is “capable of . . . ” along with other devices or parts in a certain situation. For example, “a processor configured to (set to) perform A, B, and C” may be a dedicated processor, e.g., an embedded processor, for performing a corresponding operation, or a generic-purpose processor, e.g., a Central Processing Unit (CPU) or an application processor (AP), capable of performing a corresponding operation by executing one or more software programs stored in a memory device.

The terms as used herein are used merely to describe certain embodiments and are not intended to limit the present disclosure. As used herein, singular forms may include plural forms as well unless the context explicitly indicates otherwise. Further, all the terms used herein, including technical and scientific terms, should be interpreted to have the same meanings as commonly understood by those skilled in the art to which the present disclosure pertains, and should not be interpreted to have ideal or excessively formal meanings unless explicitly defined in various embodiments of the present disclosure.

An electronic device according to various embodiments of the present disclosure, for example, may include at least one of a smartphone, a tablet personal computer (PC), a mobile phone, a video phone, an electronic book (e-book) reader, a desktop PC, a laptop PC, a netbook computer, a workstation, a server, a personal digital assistant (PDA), a portable multimedia player (PMP), an MP3 player, a mobile medical appliance, a camera, and a wearable device (e.g., smart glasses, a head-mounted-device (HMD), electronic clothes, an electronic bracelet, an electronic necklace, an electronic appcessory, an electronic tattoo, a smart mirror, or a smart watch).

According to some embodiments, the electronic device may be a smart home appliance. The home appliance may include at least one of, for example, a television, a Digital Video Disk (DVD) player, an audio, a refrigerator, an air conditioner, a vacuum cleaner, an oven, a microwave oven, a washing machine, an air cleaner, a set-top box, a home automation control panel, a security control panel, a TV box (e.g., Samsung HomeSync™, Apple TV′, or Google TV™), a game console (e.g., Xbox™ and PlayStation™), an electronic dictionary, an electronic key, a camcorder, and an electronic photo frame.

According to another embodiment, the electronic device may include at least one of various medical devices (e.g., various portable medical measuring devices (a blood glucose monitoring device, a heart rate monitoring device, a blood pressure measuring device, a body temperature measuring device, etc.), a Magnetic Resonance Angiography (MRA), a Magnetic Resonance Imaging (MRI), a Computed Tomography (CT) machine, and an ultrasonic machine), a navigation device, a Global Positioning System (GPS) receiver, an Event Data Recorder (EDR), a Flight Data Recorder (FDR), a Vehicle Infotainment Devices, an electronic devices for a ship (e.g., a navigation device for a ship, and a gyro-compass), avionics, security devices, an automotive head unit, a robot for home or industry, an automatic teller's machine (ATM) in banks, point of sales (POS) in a shop, or internet device of things (e.g., a light bulb, various sensors, electric or gas meter, a sprinkler device, a fire alarm, a thermostat, a streetlamp, a toaster, a sporting goods, a hot water tank, a heater, a boiler, etc.).

According to some embodiments, the electronic device may include at least one of a part of furniture or a building/structure, an electronic board, an electronic signature receiving device, a projector, and various kinds of measuring instruments (e.g., a water meter, an electric meter, a gas meter, and a radio wave meter). The electronic device according to various embodiments of the present disclosure may be a combination of one or more of the aforementioned various devices. The electronic device according to some embodiments of the present disclosure may be a flexible device. Further, the electronic device according to an embodiment of the present disclosure is not limited to the aforementioned devices, and may include a new electronic device according to the development of technology

Hereinafter, an electronic device according to various embodiments will be described with reference to the accompanying drawings. As used herein, the term “user” may indicate a person who uses an electronic device or a device (e.g., an artificial intelligence electronic device) that uses an electronic device.

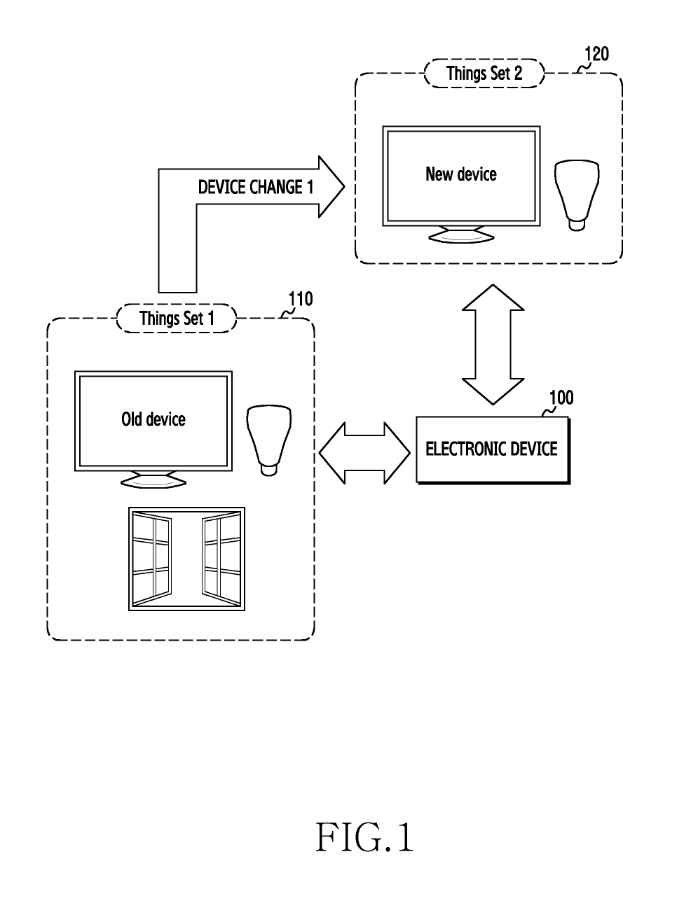

FIG. 1 is a diagram of an example of a system for controlling an IoT device, according to various embodiments of the present disclosure.

Referring to FIG. 1, an electronic device 100 may generate and store, in each mode (or scene), setting information for controlling at least one external device (for example, IoT device) included in a first device group 110. For example, when a user watches TV at home after work, the electronic device 100 may determine the setting information on at least one external device (for example, a TV, lightings, a temperature adjustment device, or a humidity control device and the like) as setting information (usage environment) of the “TV watching” mode. In some implementations, the electronic device 100 may store, along with the setting information of the mode, event information (for example, time point or control commands) for triggering the corresponding mode.

According to an embodiment, after the end of the user's work day, when detecting a control command (for example, gestures, or voice commands) for running a “TV watching” mode, an IoT control device (for example, the electronic device 100 or a separate control device) may control at least one external device of the first device group 110, so as to correspond to the setting information of the “TV watching” mode. For example, the controlling of the external device may include an operation of changing or setting the setup menu of the external device so as to correspond to the setting information of the “TV watching” mode, or an operation of driving the external device.

According to an embodiment, when controlling at least one external device (for example, an IoT device) included in the first device group 110 based on the setting information of a particular mode, the electronic device 100 may update the setting information of the particular mode based on drive information received from the external device.

When detecting at least one external device (for example, an IoT device) included in a second device group 120, the electronic device 100 may convert the setting information of a particular mode so as to correspond to the external device included in the second device group 120. For example, when detecting an external device of the second device group 120, the electronic device 100 may select a first mode (for example, “TV watching” mode) corresponding to the first device group 110 in order to establish a user preferred environment. The electronic device 100 may convert the setting information of the first mode so as to correspond to the second device group 120.

According to an embodiment, after the end of the user's work day, when detecting a control command (for example, gestures, or voice commands) for running a “TV watching” mode, an IoT control device (for example, the electronic device 100 or a separate control device) may control at least one external device of the second device group 120, so as to correspond to the converted setting information of the “TV watching” mode. For example, the controlling of the external device may include an operation of changing or setting the setup menu of the external device so as to correspond to the converted setting information of the “TV watching” mode, or an operation of driving the external device.

According to an embodiment, when controlling at least one external device (for example, IoT device) included in the second device group 110 based on the setting information of a particular mode, the electronic device 100 may update the setting information of the particular mode based on drive information received from the external device.

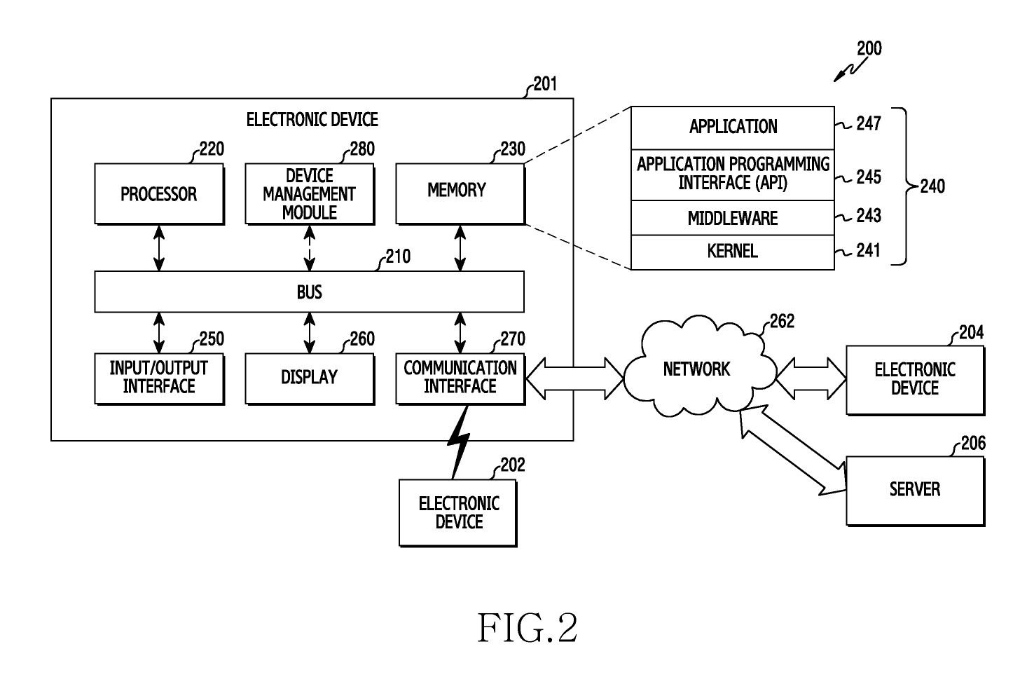

FIG. 2 is a diagram of an example of a network environment, according to various embodiments of the present disclosure. In the following, an electronic device 100 in FIG. 1 may be illustrated.

Referring to FIG. 2, an electronic device 201 in a network environment 200 is illustrated according to various embodiments. The electronic device 201 may include a bus 210, a processor 220 (e.g., including processing circuitry), a memory 230, an input/output interface 250 (e.g., including input/output circuitry), a display 260 (e.g., including a display panel and display circuitry), a communication interface 270 (e.g., including communication circuitry), and a device management module 280 (e.g., including device management circuitry). In some embodiments, the electronic device 201 may omit at least one of the above elements or may further include other elements.

The bus 210 may include, for example, a circuit which interconnects the elements 220 to 270 and delivers communication (for example, a control message and/or data) between the elements 220 to 270.

The processor 220 may include any suitable type of processing circuitry, such as one or more general-purpose processors (e.g., ARM-based processors), a Digital Signal Processor (DSP), a Programmable Logic Device (PLD), an Application-Specific Integrated Circuit (ASIC), a Field-Programmable Gate Array (FPGA), etc. For example, the processor 220 may include one or more of a Central Processing Unit (CPU), an Application Processor (AP), and a Communication Processor (CP). The processor 220, for example, may carry out operations or data processing relating to control and/or communication of one or more other elements of the electronic device 201.

According to an embodiment, the processor 220 may control at least one external device (for example, IoT device) based on the setting information of the mode, which is generated, updated, or converted by the device management module 280.

The memory 130 may include any suitable type of volatile or non-volatile memory, such as Random-access Memory (RAM), Read-Only Memory (ROM), Network Accessible Storage (NAS), cloud storage, a Solid State Drive (SSD), etc. The memory 230 may store, for example, instructions or data relevant to at least one other element of the electronic device 201. According to an embodiment, the memory 230 may store software and/or a program 240. The program 241 may include, for example, a kernel 241, middleware 243, an Application Programming Interface (API) 245, or an application program 247 (or an application), etc. At least some of the kernel 241, the middleware 243, and the API 245 may be referred to as an Operating System (OS).

The kernel 241 may control or manage system resources (for example, the bus 210, the processor 220, or the memory 230) used for performing an operation or function implemented by the other programs (for example, the middleware 243, the API 245, or the application programs 247). Furthermore, the kernel 241 may provide an interface through which the middleware 243, the API 245, or the application programs 247 may access the individual elements of the electronic device 201 to control or manage the system resources.

The middleware 243, for example, may function as an intermediary for allowing the API 245 or the application programs 247 to communicate with the kernel 241 to exchange data.

In addition, the middleware 243 may process one or more task requests received from the application programs 247 according to priorities thereof. For example, the middleware 243 may assign priorities for using the system resources (for example, the bus 210, the processor 220, the memory 230, or the like) of the electronic device 201, to at least one of the application programs 247. For example, the middleware 243 may perform scheduling or load balancing on the one or more task requests by processing the one or more task requests according to the priorities assigned thereto.

The API 245 is an interface through which the applications 247 control functions provided from the kernel 241 or the middleware 243, and may include, for example, at least one interface or function (for example, instruction) for file control, window control, image processing, or text control.

According to an embodiment, the memory 230 may store setting information for at least one mode for controlling the IoT device. For example, the memory 230 may store setting information for each mode according to each device group. For example, the memory 230 may store the setting information for each mode and information on the device group corresponding to the corresponding setting information.

The input/output interface 250 may function as, for example, an interface that may transfer instructions or data input from a user or another external device to the other element(s) of the electronic device 201. Also, the input/output interface 250 may output instructions or data received from other element(s) of the electronic device 201 to the user or another external device.

The display 260 may include, for example, a Liquid Crystal Display (LCD), a Light-Emitting Diode (LED) display, an Organic Light-Emitting Diode (OLED) display, a MicroElectroMechanical Systems (MEMS) display, and an electronic paper display. The display 260 may display, for example, various types of contents (for example, text, images, videos, icons, or symbols) for the user. The display 260 may include a touch screen and receive, for example, a touch, gesture, proximity, or hovering input by using an electronic pen or the user's body part.

The communication interface 270 may set communication between, for example, the electronic device 201 and an external device (for example, a first external electronic device 202, a second external electronic device 204, or a server 206). For example, the communication interface 270 may be connected to a network 262 through wireless or wired communication to communicate with the external device (for example, the second external electronic device 204 or the server 206).

The wireless communication may use at least one of, for example, Long Term Evolution (LTE), LTE-Advance (LTE-A), Code Division Multiple Access (CDMA), Wideband CDMA (WCDMA), Universal Mobile Telecommunications System (UMTS), WiBro (Wireless Broadband), and Global System for Mobile Communications (GSM), as a cellular communication protocol. Further, the wireless communication may include, for example, short-range communication. The short-range communication may include at least one of, for example, Wi-Fi, Bluetooth, Near Field Communication (NFC), and Global Navigation Satellite System (GNSS). The GNSS may include at least one of, for example, a Global Positioning System (GPS), a Global Navigation Satellite System (Glonass), a Beidou Navigation Satellite System (hereinafter referred to as “Beidou”), and a European Global Satellite-based Navigation System (Galileo), according to a use area, a bandwidth, or the like. Hereinafter, in the present disclosure, the “GPS” may be interchangeably used with the “GNSS”. The wired communication may include, for example, at least one of a Universal Serial Bus (USB), a High Definition Multimedia Interface (HDMI), Recommended Standard-232 (RS-232, and a Plain Old Telephone Service (POTS). The network 262 may include at least one of a communication network such as a computer network (e.g., a LAN or a WAN), the Internet, and a telephone network.

Each of the first and second external electronic devices 202 and 204 may be a device which is the same as or different from the electronic device 201. According to an embodiment, the server 206 may include a group of one or more servers. According to various embodiments, all or some of the operations performed in the electronic device 201 may be performed in another electronic device or a plurality of electronic devices (e.g., the electronic devices 202 and 204 or the server 206). According to an embodiment, when the electronic device 201 has to perform some functions or services automatically or in response to a request, the electronic device 201 may make a request for performing at least some functions relating thereto to another device (for example, the electronic device 202 or 204 or the server 206) instead of performing the functions or services by itself or in addition. Another electronic device (for example, the electronic device 202 or 204, or the server 206) may execute the requested functions or the additional functions, and may deliver a result of the execution to the electronic device 201. The electronic device 201 may process the received result as it is or additionally to provide the requested functions or services. To achieve this, for example, cloud computing, distributed computing, or client-server computing technology may be used.

The device management module 280 may generate or update the setting information for controlling an IoT device. For example, the device management module 280 may generate and store the setting information for controlling the IoT device by each mode.

According to an embodiment, when a device group for executing a mode is changed, the device management module 280 may convert the setting information of a particular mode so as to correspond to the changed device group.

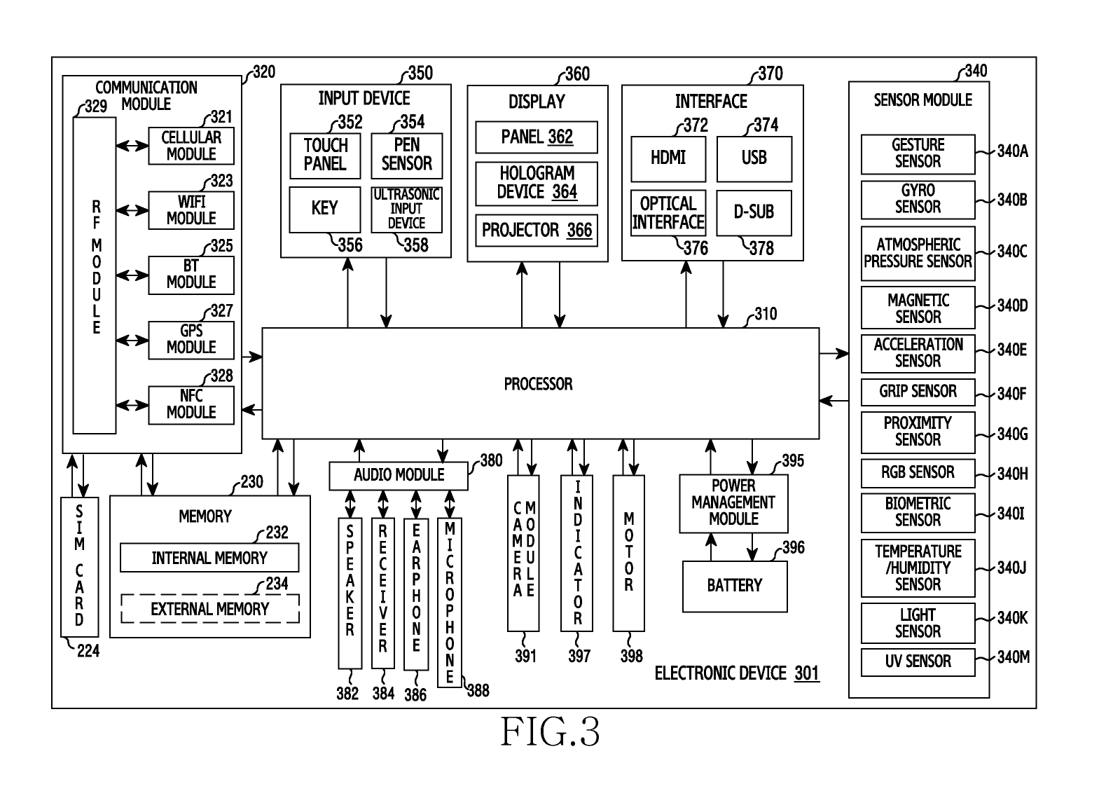

FIG. 3 is a diagram of an example of an electronic device, according to various embodiments of the present disclosure. The electronic device 301 may include, for example, the entirety or a part of the electronic device 201 illustrated in FIG. 2. The electronic device 301 may include one or more processors (for example, AP) 310, a communication module 320, a subscriber identification module 324, a memory 330, a sensor module 340, an input device 350, a display 360, an interface 370, an audio module 380, a camera module 391, a power management module 395, a battery 396, an indicator 397, and a motor 398.

The processor 310 may control a plurality of hardware or software components connected to the processor 310 by driving an operating system or an application program and perform processing of various pieces of data and calculations. The processor 310 may be implemented by, for example, a System on Chip (SoC). According to an embodiment, the processor 310 may further include a Graphic Processing Unit (GPU) and/or an image signal processor. The processor 310 may include at least some (for example, a cellular module 321 of the elements illustrated in FIG. 3. The processor 310 may load, into a volatile memory, instructions or data received from at least one (for example, a non-volatile memory) of the other elements and may process the loaded instructions or data, and may store various data in a non-volatile memory.

The communication module 320 may have a configuration equal or similar to that of the communication interface 270 of FIG. 2. The communication module 320 may include, for example, the cellular module 321, a Wi-Fi module 323, a Bluetooth (BT) module 325, a GNSS module 327 (for example, a GPS module, a Glonass module, a Beidou module, or a Galileo module), an NFC module 328, and a Radio Frequency (RF) module 329.

The cellular module 321 may provide a voice call, an image call, a text message service, or an Internet service through, for example, a communication network. According to an embodiment, the cellular module 321 may identify and authenticate the electronic device 301 within a communication network using a subscriber identification module (for example, the SIM card 324). According to an embodiment, the cellular module 321 may perform at least some of the functions that the processor 310 may provide. According to an embodiment of the present disclosure, the cellular module 321 may include a Communication Processor (CP).

The Wi-Fi module 323, the Bluetooth module 325, the GNSS module 327, or the NFC module 328 may include, for example, a processor that processes data transmitted and received through the corresponding module. According to some embodiments, at least some (for example, two or more) of the cellular module 321, the Wi-Fi module 323, the Bluetooth module 325, the GNSS module 327, and the NFC module 328 may be included in one Integrated Chip (IC) or IC package.

The RF module 329 may transmit/receive, for example, a communication signal (for example, an RF signal). The RF module 329 may include, for example, a transceiver, a Power Amp Module (PAM), a frequency filter, a Low Noise Amplifier (LNA), or an antenna. According to another embodiment of the present disclosure, at least one of the cellular module 321, the Wi-Fi module 323, the Bluetooth module 325, the GNSS module 327, and the NFC module 328 may transmit and receive RF signals through a separate RF module.

The subscriber identification module 324 may include, for example, a card including a subscriber identity module and/or an embedded SIM, and may contain unique identification information (for example, an Integrated Circuit Card Identifier (ICCID)) or subscriber information (for example, an International Mobile Subscriber Identity (IMSI)).

The memory 330 (for example, a memory 230) may include, for example, an internal memory 332 or an external memory 334. The internal memory 332 may include at least one of a volatile memory (for example, a Dynamic Random Access Memory (DRAM), a Static RAM (SRAM), a Synchronous Dynamic RAM (SDRAM), and the like) and a non-volatile memory (for example, a One Time Programmable Read Only Memory (OTPROM), a Programmable ROM (PROM), an Erasable and Programmable ROM (EPROM), an Electrically Erasable and Programmable ROM (EEPROM), a mask ROM, a flash ROM, a flash memory (for example, a NAND flash memory or a NOR flash memory), a hard disk drive, a Solid State Drive (SSD), and the like).

The external memory 334 may further include a flash drive, for example, a Compact Flash (CF), a Secure Digital (SD), a Micro Secure Digital (Micro-SD), a Mini Secure Digital (Mini-SD), an eXtreme Digital (xD), Multi-media Card (MMC), a memory stick, or the like. The external memory 334 may be functionally and/or physically connected to the electronic device 301 through various interfaces.

The sensor module 340 may measure a physical quantity or detect an operation state of the electronic device 301, and may convert the measured or detected information into an electrical signal. The sensor module 340 may include, for example, at least one of a gesture sensor 340A, a gyro sensor 340B, an atmospheric pressure sensor 340C, a magnetic sensor 340D, an acceleration sensor 340E, a grip sensor 340F, a proximity sensor 340G, a color sensor 340H (for example, a red, green, blue (RGB) sensor), a biometric sensor 340I, a temperature/humidity sensor 340J, a light sensor 340K, and an ultraviolet (UV) sensor 340M. Additionally or alternatively, the sensor module 340 may include, for example, an E-nose sensor, an electromyography (EMG) sensor, an electroencephalogram (EEG) sensor, an electrocardiogram (ECG) sensor, an Infrared (IR) sensor, an iris sensor, and/or a fingerprint sensor. The sensor module 340 may further include a control circuit for controlling one or more sensors included therein. In some embodiments, the electronic device 301 may further include a processor configured to control the sensor module 340 as a part of or separately from the processor 310, and may control the sensor module 340 while the processor 310 is in a sleep state.

The input device 350 may include, for example, a touch panel 352, a (digital) pen sensor 354, a key 356, and an ultrasonic input unit 358. The touch panel 352 may use at least one of, for example, a capacitive type, a resistive type, an infrared type, and an ultrasonic type. Also, the touch panel 352 may further include a control circuit. The touch panel 352 may further include a tactile layer and provide a tactile reaction to the user.

The (digital) pen sensor 354 may include, for example, a recognition sheet which is a part of the touch panel or is separated from the touch panel. The key 356 may include, for example, a physical button, an optical key or a keypad. The ultrasonic input device 358 may detect ultrasonic waves generated by an input tool through a microphone (for example, a microphone 388) and identify data corresponding to the detected ultrasonic waves.

The display 360 (for example, the display 260) may include a panel 362, a hologram device 364, or the projector 366. The panel 362 may include a configuration identical or similar to that of the display 260 illustrated in FIG. 2. The panel 362 may be implemented to be, for example, flexible, transparent, or wearable. The panel 362 and the touch panel 352 may be implemented as one module. The hologram 364 may show a three dimensional image in the air by using an interference of light. The projector 366 may display an image by projecting light onto a screen. The screen may be located, for example, inside or outside the electronic device 301. According to an exemplary embodiment, the display 360 may further include a control circuit for controlling the panel 362, the hologram device 364, or the projector 366.

The interface 370 may include, for example, a High-Definition Multimedia Interface (HDMI) 372, a Universal Serial Bus (USB) 374, an optical interface 376, or a D-subminiature (D-sub) 378. The interface 370 may be included in, for example, the communication interface 270 illustrated in FIG. 2. Additionally or alternatively, the interface 370 may include, for example, a Mobile High-definition Link (MHL) interface, a Secure Digital (SD) card/Multi-Media Card (MMC) interface, or an Infrared Data Association (IrDA) standard interface.

The audio module 380 may bilaterally convert, for example, a sound and an electrical signal. At least some elements of the audio module 380 may be included in, for example, the input/output interface 245 illustrated in FIG. 2. The audio module 380 may process sound information which is input or output through, for example, a speaker 382, a receiver 384, earphones 386, the microphone 388 or the like.

The camera module 391 is a device which may photograph a still image and a dynamic image. According to an embodiment, the camera module 291 may include one or more image sensors (for example, a front sensor or a back sensor), a lens, an Image Signal Processor (ISP) or a flash (for example, LED or xenon lamp).

The power management module 395 may manage, for example, power of the electronic device 301. According to an embodiment, the power management module 395 may include a Power Management Integrated Circuit (PMIC), a charger Integrated Circuit (IC), or a battery or fuel gauge. The PMIC may have a wired and/or wireless charging scheme. Examples of the wireless charging method may include, for example, a magnetic resonance method, a magnetic induction method, an electromagnetic method, and the like. Additional circuits (e.g., a coil loop, a resonance circuit, a rectifier, etc.) for wireless charging may be further included. The battery gauge may measure, for example, a residual quantity of the battery 396, and a voltage, a current, or a temperature during the charging. The battery 396 may include, for example, a rechargeable battery or a solar battery.

The indicator 397 may display a particular state (for example, a booting state, a message state, a charging state, or the like) of the electronic device 301 or a part (for example, the processor 310) of the electronic device 301. The motor 398 may convert an electrical signal into mechanical vibration, and may generate vibration, a haptic effect, or the like. Although not illustrated, the electronic device 301 may include a processing unit (for example, a GPU) for supporting a mobile television (TV). The processing unit for supporting mobile TV may, for example, process media data according to a certain standard such as Digital Multimedia Broadcasting (DMB), Digital Video Broadcasting (DVB), or mediaFlo™.

Each of the above-described component elements of hardware according to the present disclosure may be configured with one or more components, and the names of the corresponding component elements may vary based on the type of electronic device. The electronic device according to various embodiments of the present disclosure may include at least one of the aforementioned elements. Some elements may be omitted or other additional elements may be further included in the electronic device. Also, some of the hardware components according to various embodiments may be combined into one entity, which may perform functions identical to those of the relevant components before the combination.

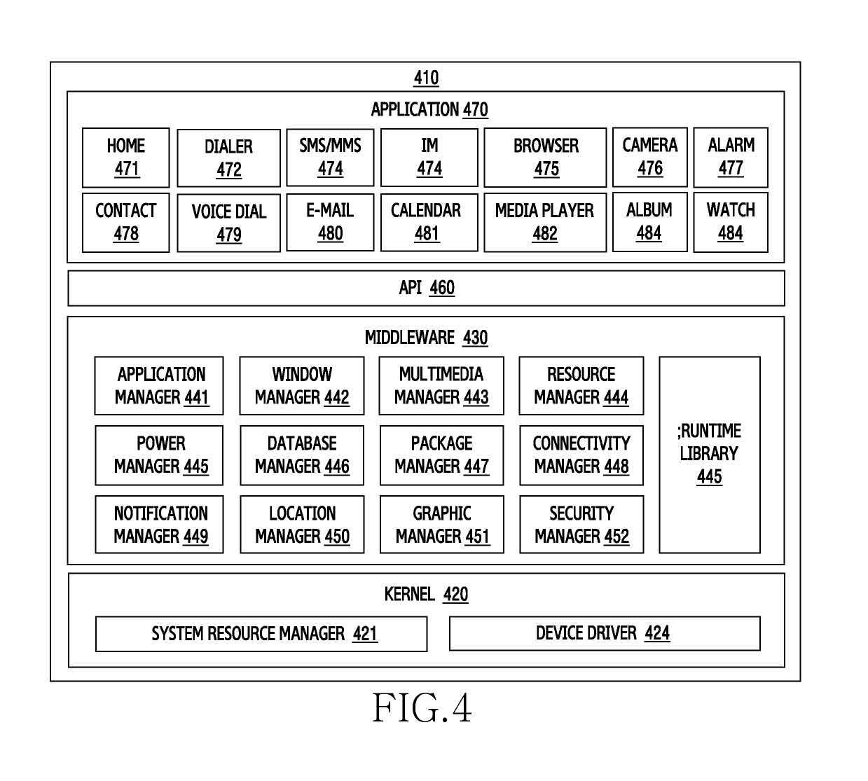

FIG. 4 is a diagram of an example of a program module, according to various embodiments of the present disclosure. According to an embodiment, a program module 410 (for example, the program 240) may include an Operating System (OS) for controlling resources related to the electronic device (for example, the electronic device 201 and/or various applications (for example, the application programs 247 executed in the operating system. The operating system may be, for example, Android™, iOS™, Windows™, Symbian™, Tizen™, Bada™, or the like.

The program module 410 may include a kernel 420, middleware 430, an Application Programming Interface (API) 460, and/or applications 470. At least some of the program module 410 may be preloaded on the electronic device, or may be downloaded from an external electronic device (for example, the electronic device 202 or 204, or the server 206).

The kernel 420 (for example, the kernel 241) may include, for example, a system resource manager 421 and/or a device driver 423. The system resource manager 421 may perform the control, allocation, retrieval, or the like of system resources. According to an embodiment, the system resource manager 421 may include a process manager, a memory manager, a file system manager, or the like. The device driver 423 may include, for example, a display driver, a camera driver, a Bluetooth driver, a shared memory driver, a USB driver, a keypad driver, a Wi-Fi driver, an audio driver, or an Inter-Process Communication (IPC) driver.

The middleware 430 may provide, for example, a function commonly required by the applications 470, or may provide various functions to the applications 470 through the API 460 so that the applications 470 can efficiently use limited system resources within the electronic device. According to an embodiment, the middleware 430 (for example, the middleware 243 may include, for example, at least one of a runtime library 435, an application manager 441, a window manager 442, a multimedia manager 443, a resource manager 444, a power manager 445, a database manager 446, a package manager 447, a connectivity manager 448, a notification manager 449, a location manager 450, a graphic manager 451, and a security manager 452.

The runtime library 435 may include a library module which a compiler uses in order to add a new function through a programming language while the applications 470 are being executed. The runtime library 435 may perform input/output management, memory management, the functionality for an arithmetic function, or the like.

The application manager 441 may manage, for example, a life cycle of at least one of the applications 470. The window manager 442 may manage Graphical User Interface (GUI) resources used for the screen. The multimedia manager 443 may determine a format required to reproduce various media files, and may encode or decode a media file by using a coder/decoder (codec) appropriate for the corresponding format. The resource manager 444 may manage resources, such as a source code, a memory, a storage space, and the like of at least one of the applications 470.

The power manager 445 may operate together with a Basic Input/Output System (BIOS) to manage a battery or power, and may provide power information required for the operation of the electronic device. The database manager 446 may generate, search for, and/or change a database to be used by at least one of the applications 470. The package manager 447 may manage the installation or update of an application distributed in the form of a package file.

The connectivity manager 448 may manage a wireless connection such as, for example, Wi-Fi or Bluetooth. The notification manager 449 may display or notify of an event, such as an arrival message, an appointment, a proximity notification, and the like, in such a manner as not to disturb the user. The location manager 450 may manage location information of the electronic device. The graphic manager 451 may manage a graphic effect, which is to be provided to the user, or a user interface related to the graphic effect. The security manager 452 may provide various security functions required for system security, user authentication, and the like. According to an embodiment, when the electronic device (for example, the electronic device 201 has a telephone call function, the middleware 430 may further include a telephony manager for managing a voice call function or a video call function of the electronic device.

The middleware 430 may include a middleware module that forms a combination of various functions of the above-described elements. The middleware 430 may provide a module specialized for each type of OS in order to provide a differentiated function. Also, the middleware 430 may dynamically delete some of the existing elements, or may add new elements.

The API 460 (for example, the API 245) is, for example, a set of API programming functions, and may be provided with a different configuration according to an OS. For example, in the case of Android or iOS, one API set may be provided for each platform. In the case of Tizen, two or more API sets may be provided for each platform.

The applications 470 (for example, the application programs 247 may include, for example, one or more applications which can provide functions such as home 471, dialer 472, SMS/MMS 473, Instant Message (IM) 474, browser 475, camera 476, alarm 477, contacts 478, voice dialer 479, email 480, calendar 481, media player 482, album 483, clock 484, health care (for example, measure exercise quantity or blood sugar), or environment information (for example, atmospheric pressure, humidity, or temperature information).

According to an embodiment, the applications 470 may include an application (hereinafter, referred to as an “information exchange application” for convenience of description) supporting information exchange between the electronic device (for example, the electronic device 201 and an external electronic device (for example, the electronic device 202 or 204). The information exchange application may include, for example, a notification relay application for transferring specific information to an external electronic device or a device management application for managing an external electronic device.

For example, the notification relay application may include a function of transferring, to the external electronic device (for example, the electronic device 202 or 204), notification information generated from other applications of the electronic device 101 (for example, an SMS/MMS application, an e-mail application, a health management application, or an environmental information application). Further, the notification relay application can, for example, receive notification information from the external electronic device and provide the received notification information to a user.

The device management application may manage (for example, install, delete, or update), for example, at least one function of an external electronic device (for example, the electronic device 202 or 204) communicating with the electronic device (for example, a function of turning on/off the external electronic device itself (or some components) or a function of adjusting luminance (or a resolution) of the display), applications operating in the external electronic device, or services provided by the external electronic device (for example, a call service and a message service).

According to an embodiment, the applications 470 may include applications (for example, a health care application of a mobile medical appliance or the like) designated according to attributes of the external electronic device (for example, the electronic device 202 or 204). According to an embodiment, the application 470 may include an application received from the external electronic device (for example, the server 206, or the electronic device 202 or 204). According to an embodiment, the application 470 may include a preloaded application or a third party application which can be downloaded from the server. Names of the elements of the program module 410, according to the above-described embodiments of the present disclosure, may change depending on the type of OS

According to various exemplary embodiments of the present disclosure, at least some of the program module 410 may be implemented in software, firmware, hardware, or a combination of two or more thereof. At least some of the program module 410 may be implemented (e.g., executed) by, for example, the processor (e.g., the processor 310). At least some of the program module 410 may include, for example, a module, a program, a routine, a set of instructions, and/or a process for performing one or more functions.

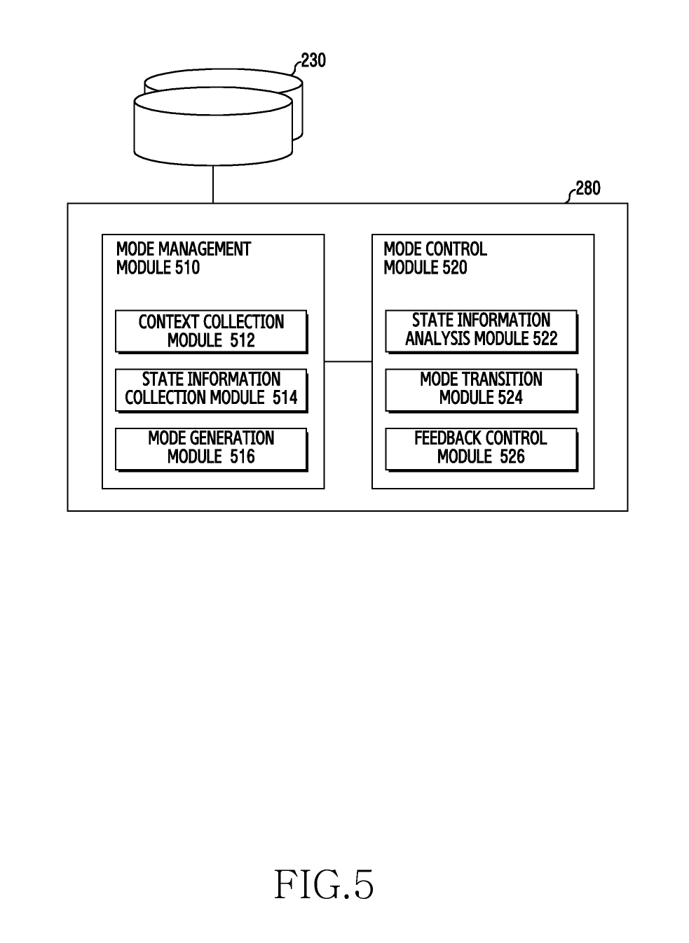

FIG. 5 is a diagram of an example of a device management module, according to various embodiments of the present disclosure.

Referring to FIG. 5, the device management module 500 (for example, the device management module 280) may include a mode management module 510 and the mode control module 520.

The mode management module 510 may generate, for each mode, setting information for controlling at least one external device (for example, an IoT device).

According to an embodiment, the mode management module 510 may include a context collection module 512, a state information collection module 514, and a mode generation module 516.

The context collection module 512 may collect user context information of the electronic device (for example, an electronic device 200). For example, the context collection module 512 may collect user activity information such as a user's location, sleep schedule, end of the user's workday, etc., and a user's profile.

The state information collection module 514 may collect information on at least one external device (for example, IoT device) located in the vicinity of the electronic device 200 and information on the surrounding environment of the electronic device 200. For example, the state information collection module 514 may collect the brightness of a light bulb, the temperature settings of air-conditioning and heating devices, a TV channel, and information on the preferred volume state. Specifically, when setting the heating temperature to 30 degrees by an electronic device 200 in-the home, the state information collection module 514 may collect the current home temperature, the time it takes to reach 30 degrees, and amount of heat required for raising the temperature. For example, the state information collection module 514 may collect information on the external device from a hub, a network, and a server. In some implementations, the information on the external device may include identification information (unique ID) on the external device, the type of external device, a service category (type of service), a manufacturer, capabilities, etc., and the information on the external device may be referred to as a profile of the external device. The available resources may include information on the function which can be performed by the external device.

The mode generation module 516 may generate mode data (profile) by mapping the user context information collected by the context collection module 512 to the state information collected by the state collection module 514. For example, the mode data (or mode profile) may include identification information (ID) indicating the mode (e.g., a mode ID) and setting information of the external device (e.g., an indication of one or more configuration settings of the external device). For example, the mode generation module 516 may generate data of a “coming home” mode by mapping the surrounding information collected after coming home to the user's activity information. Specifically, the mode generation module 516 may generate the mode data (or profile) of the “coming home” mode by mapping to the mode ID one or more configuration settings for turning on the lights of the front door and in a living room to the “coming home” mode, and one or more configuration settings for turning on the TV or tuning the TV to channel 7.

The mode generation module 516 may store the mode data in the memory 540 (for example, the memory 230) and/or a server.

The mode control module 520 may update or convert the setting information of the mode so as to correspond to at least one external device (for example, an IoT device).

According to an embodiment, the mode control module 520 may include a state information analysis module 522, a mode transition module 524, and a feedback control module 526.

The state information analysis module 522 may analyze the information on the at least one external device (for example, an IoT device) located in the vicinity of the electronic device 200. For example, the state information analysis module 522 may process the information on the external device provided from the mode management module 510 so as to determine the type of external device, setting information, the manufacturer, etc.

According to an embodiment, the state information analysis module 522 may acquire in advance and analyze, before the arrival of the user, information on the external device located at a position to which the user of the electronic device 200 will move. For example, the state information analysis module 522 may estimate a user's future location by analyzing the schedule information, navigation destination information, reservation information, etc. stored in the electronic device 200. The state information analysis module 522 may acquire, through the server, information on the at least one external device that is present at the future location and analyze the information.

The mode transition module 524 may map previously generated mode data and a result of analysis of the state information analysis module 522. For example, the mode transition module 524 may convert the mode data to correspond to the information on the external device provided from the state information analysis module 522. Specifically, the mode management module 510 may set the temperature of a first air conditioner included in the first device group to 20 degrees which is the setting information of a “room temperature” mode in a first area. The mode transition module 524 may detect a second air conditioner included in the second device group in a second area. The mode transition module 524 may convert the data (setting information) of the “room temperature” mode to include a set temperature (for example, 18 degrees) of the second air conditioner which can provide the same actual measurement temperature as the actually measured temperature (for example, 23 degrees) when setting the set temperature of the first air conditioner to 20 degrees in accordance with the setting information of the “room temperature” mode. For example, the first device group and the second device group may represent a device group having external devices of different platforms included therein. For example, the external device included in the first device group and the second device may be capable of performing the same function (for example, image display) or the same service type, however a command system and driving conditions for controlling external devices or the type of external device (for example, a TV, monitor, etc.) may be different according to manufacturers, APIs, etc. In some implementations, the service type may include an indication of a function performed by the external device (e.g., a lighting function, a television function, a heating function, etc.)

According to an embodiment, the mode transition module 524 may convert at least some of the mode data based on available resources of the external device. For example, the mode transition module 524 may detect a function supported by the external device among the mode data based on the available resources of the external device. The mode transition module 524 may convert the setting information on the function supported by the external device among the mode data so as to correspond to the information on the external device provided from the state information analysis module 522.

According to an embodiment, the memory 540 may separately store data of the “room temperature” mode corresponding to the second device group from data of the “room temperature” mode corresponding to the first device group, according to a result of the mode conversion of the mode transition module 524.

According to an embodiment, the memory 540 may update pre-stored data of the “room temperature” mode corresponding to the first device group to the data of the “room temperature” mode corresponding to the second device group according to the result of mode conversion of the mode transition module 524.

According to an embodiment, the memory 540 may add the setting information of the second device group to the data of the “room temperature” mode so as to be distinguished from the pre-set setting information of the first device group, according to the result of mode conversion of the mode transition module 524.

The feedback control module 526 may extract the update information of the mode data by using the driving information on the at least one external device or input information received through the input/output interface (for example, the input/output interface 250). For example, the feedback control module 526 may extract a volume adjustment value for updating data in the corresponding mode by using TV volume adjustment information of the user.

The mode transition module 524 may update the data in the corresponding mode based on the update information of the mode data provided from the feedback control module 526. For example, the mode transition module 524 may update the setting information of the corresponding mode based on the update information of the mode data provided from the feedback control module 526.

According to an embodiment, the device management module 500 may further include an object management module for collecting state information on the at least one external device which is located in the vicinity of the electronic device 200. In such instances, the object management module and the state information collection module 514 of the mode management module 510 may have different ranges, targets, and time points for collecting state information.

According to various embodiments of the present disclosure, the electronic device 200 may be configured to perform all functions or at least some functions of the device management module 280.

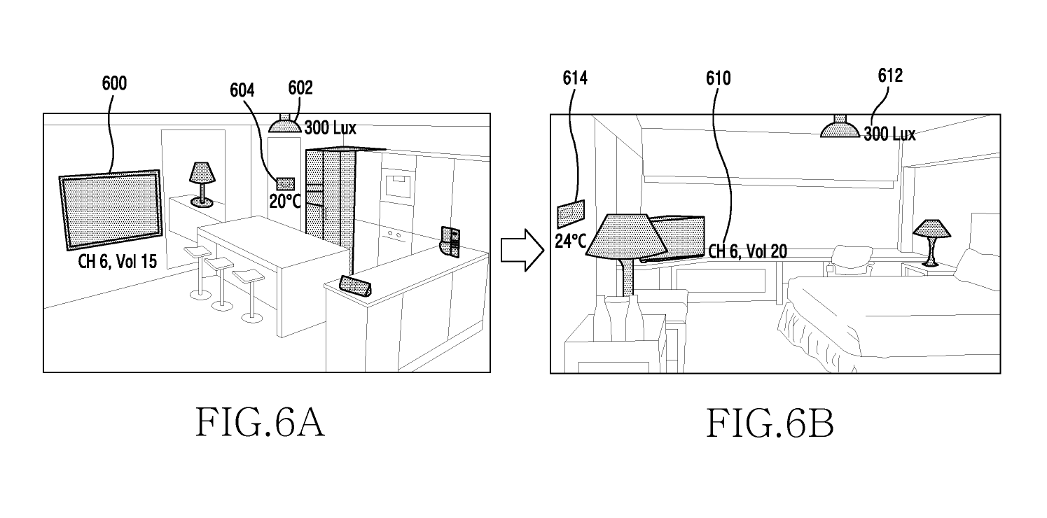

FIGS. 6A-B are diagrams illustrating an example of a technique for determining setting information, according to various embodiments of the present disclosure.

Referring to FIG. 6A, an electronic device (for example, electronic devices 100, 201, 301) may activate TV 600 by setting channel 6 and volume 15, and generate the data of a “home” mode by setting the brightness of a light 602 to 300 Lux and the temperature adjustment information 604 to 20 degrees.

According to an embodiment, when the user moves to a hotel and selects the “home” mode, the electronic device may convert the setting information of the “Home” mode so as to correspond to the information on the external device of the hotel as shown in FIG. 6B. For example, when external devices of the home and the hotel are included in an identical (or otherwise similar) device group, the electronic device may maintain the setting information of the “home” mode. When the external devices located at the home and the hotel are part of different device groups, the electronic device may convert the setting information of the “home” mode so to correspond to information on the external device of the hotel.

According to an embodiment, the electronic device may set the set temperature of the first temperature adjustment device (e.g., heater, air conditioner, etc.) included in the first device group to 20 degrees at home. The electronic device may sense a second temperature adjustment device included in the second device group in the hotel. As shown in FIG. 6B (indicated by reference numeral 614), the electronic device may convert the data (setting information) of the “home” mode to include a set temperature of 24 degrees of the second temperature adjustment device which can provide the same actual measurement temperature as the actually measured temperature (for example, 23 degrees) when setting the set temperature of the first temperature adjustment device to 20 degrees in accordance with the setting information of the “home” mode. In other words, converting the setting information of the home “mode” may include generating a second setting value for the second device (e.g., 24 degrees) based on a measured performance of the first device (e.g., heating the room to 23 degrees) when the first device is operated in accordance with a first setting value (e.g., 20 degrees)

According to an embodiment, the electronic device may set up a channel of a first TV included in the first device group to 6 and set the volume of the TV to 15. The electronic device may detect a second TV included in the second device group in the hotel. As shown in FIG. 6B, the electronic device may convert the data (setting information) of the “home” mode to include Volume 20 of the second TV which can provide the same sound output as the actual sound output when setting the volume of the first TV to 15 in accordance with the setting information of the “home” mode (indicated by reference numeral 610).

According to an embodiment, the electronic device may maintain data (setting information) of a broadcast channel (for example, channel 6) of the “home” mode since TVs of the home and the hotel provide the same broadcast channel as shown in FIG. 6B (indicated by reference numeral 610).

According to an embodiment, when the lighting apparatus at the home and the hotel are included in the same device group as shown in FIG. 6B, the electronic device may maintain data (setting information) on the brightness of the lighting apparatus of the “home” mode (indicated by reference numeral 612).

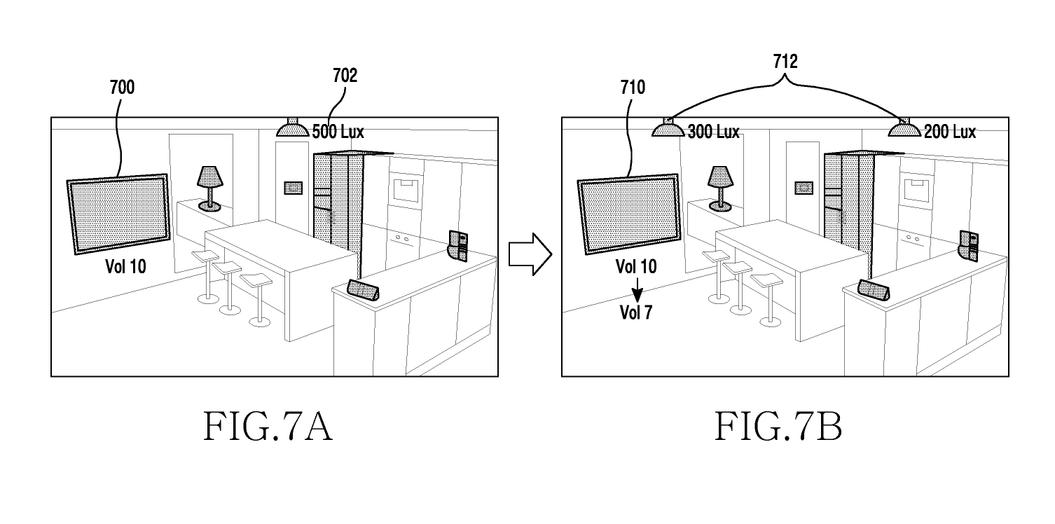

FIGS. 7A-B are diagrams illustrating an example of a technique for updating setting information, according to various embodiments of the present disclosure.

Referring to FIG. 7A, an electronic device (for example, the electronic devices 100, 201, and 301) may activate a TV 700 by setting a volume to 10 and generate data of a “coming home” mode by setting information of the light brightness to 500 Lux.

According to an embodiment, when the user adjusts the TV volume (preference volume) to 7, the electronic device my update the setting information on the TV volume of the “coming home” mode to 7 as shown in FIG. 7B (indicated by reference numeral 710).

According to an embodiment, when an additional light is installed in the home as shown in FIG. 7B (indicated by reference numeral 712), the electronic device may update the brightness of the first light of the “coming home” mode to 300 Lux and set the brightness of the second light to 200 Lux in order to maintain the light brightness of the “coming home” mode. Thus in some implementations, the electronic device may update a configuration setting in accordance with which the first light is operated in response to a new device being added to the device group that is being controlled by the electronic device in accordance with the setting information.

According to various embodiments of the present disclosure, an electronic device may include a processor-implemented device management module, the device management module may be configured to identify a first device group including at least one external device, select a mode for controlling the at least one external device, convert setting information of the mode so as to correspond to the first device group, and control the at least one external device based on at least some of the converted setting information.

According to various embodiments, when the setting information of the mode is configured to correspond to the second device group, the device management module may be configured to convert the setting information of the mode so as to correspond to the first device group.

According to various embodiments, the first device group includes a first device, and the second device group may include a second device for performing the same function as that of the first device.

According to various embodiments, the first device group may be configured to include a first device of a first service type, and the second device group may be configured to include a second device of the first service type.

According to various embodiments, the first device group corresponds to a first position, and the second device group may correspond to the second position.

According to various embodiments, the device management module may identify the first device group based on available resources in the first position.

According to various embodiments, the device management module may be configured to generate different configuration information for at least one external device included in the first device group, based on at least some of the setting information of the mode.

According to various embodiments, the device management module may be configured to transmit the different setting information to the at least one external device.

According to various embodiments, the device management module may be configured to generate the different setting information further based on environment information on the electronic device.

According to various embodiments, the environment information may include a user preference or the feedback on the electronic device.

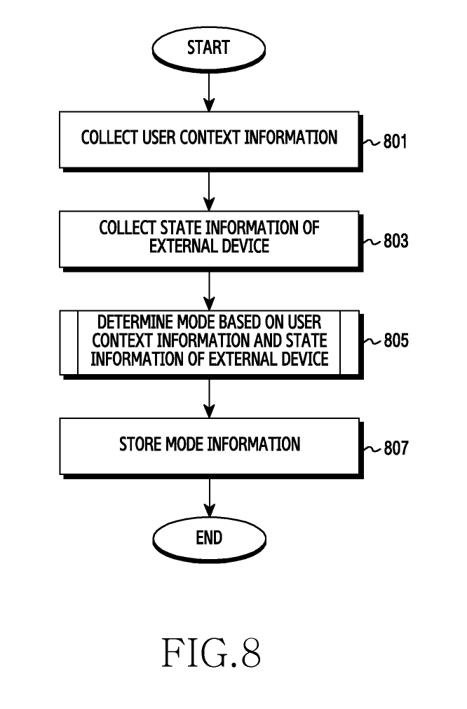

FIG. 8 is a flowchart of an example of a process, according to various embodiments of the present disclosure.

Referring to FIG. 8, in operation 801, an electronic device (for example, the electronic devices 100, 201, and 301) may collect user context information. For example, the device management module 280 of the electronic device 200 may collect the user context information such as user profiles, user behavior state, and location. In such instances, the processor 220 may collect user behavior state and location information through the sensor module 340.

In operation 803, the electronic device may collect the state information of an external device (or peripheral device). For example, the device management module 280 of the electronic device 200 may collect information on at least one external device adjacent to the electronic device 200 and environmental information of the electronic device 200.

In operation 805, the electronic device may determine a single mode for controlling an IoT device based on the user context information and the state information of the external device. For example, the mode generation module 516 of the device management module 280 may generate mode data (profile) by mapping the user context information collected by the context collection module 512 and the state information collected by the state information collection module 514.

In operation 807, the electronic device may store mode data determined in operation 805. For example, the mode generation module 516 may store the mode data in the memory 230 or an extra server.

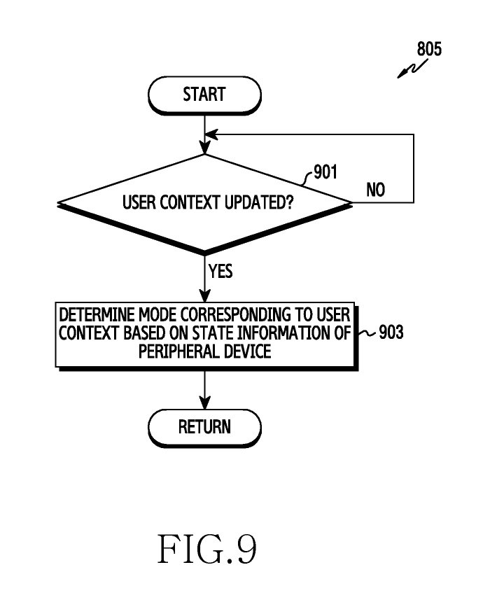

FIG. 9 is a flowchart of an example of a sub-process for performing operation 805 of the process of FIG. 8, according to various embodiments of the present disclosure.

Referring to FIG. 9, in operation 901, an electronic device (for example, the electronic devices 100, 201, and 301) may detect whether the user context information is updated. For example, the context collection module 512 of the device management module 280 may detect whether the user context of the user of the electronic device 200 is changed from “showering” to “watching news”.

In operation 903, when the user context information is updated, the electronic device may generate mode data corresponding to the user context based on the state information of the external device. For example, when the user begins watching the news (e.g., when the user tunes to a particular channel at a specific time), the mode generation module 516 may generate mode data corresponding to the user context of “watching news” by using the state information collected by the state information collection module 514 while the user is watching the news.

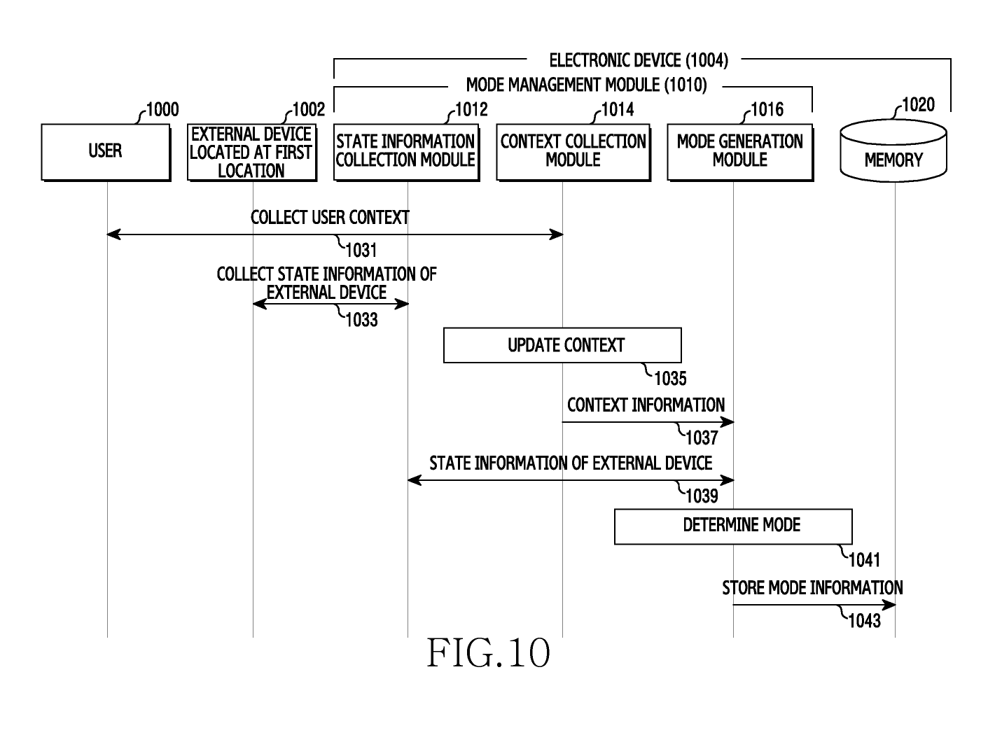

FIG. 10 is a sequence diagram of an example of a process, according to various embodiments of the present disclosure.

Referring to FIG. 10, a context collection module 1014 (for example, the context collection module 512) of an electronic device 1004 (for example, electronic devices 100, 201, and 301) may collect context information of the user 1000 (operation 1031). For example, the context collection module 1014 may collect the context information of the user 1000 in response to the occurrence of the context information collection event. In some implementations, the context information collection event may occur periodically and/or repeatedly.

The state information collection module 1012 (for example, the state information collection module 514) of the electronic device 1004 may collect the state information on at least one external device (for example, an IoT device) 1002 included in the first area in which the electronic device 1004 is located (operation 1033). For example, the state information collection module 1012 may collect the state information on at least one external device 1002 located in the first area in response to the occurrence of the state information collection event of the external device. In some implementations, the state information collection event may occur periodically and/or repeatedly.

When the user context is updated (operation 1035), the context collection module 1014 may transmit the updated user context information to a mode generation module 1016 (for example, the mode generation module 516) (operation 1037).

The mode generation module 1016 may acquire the state information of the external device collected by the state information collection module 1012 in response to the reception of the updated user context information (operation 1039). For example, the mode generation module 1016 may transmit the state information request signal to the state information collection module 1012 in response to the reception of the updated user context information. The mode generation module 1016 may receive the state information of the external device from the state information collection module 1012 in response to the state information request signal.

The mode generation module 1016 may generate a single mode for controlling at least one external device 1002 located at the first area by mapping the updated user context information and the state information of the external device collected by the state information collection module 1012 (operation 1041). For example, the mode generation module 516 may generate data of a “watching news” mode by mapping the surrounding environment information collected by the state information collection module 1012 to the user's activity information such as watching the news. In such instances, the mode generation module 516 may detect collection information that is mapped based on a time point of collecting information and a location of the state information collection module 1012 and the context collection module 1014.

The mode generation module 1016 may store the generated mode data in the memory 1020 (for example, memory 230) (operation 1043). The mode generation module 1016 may associate event information (or an activation time or an activation command of the corresponding mode) for activating the generated mode data with the mode data and store the associated data in the memory 1020.

According to various embodiments of the present disclosure, when the user generates an event for activating the “watching news” mode after work, an IoT control device (for example, an electronic device or a separate control device) may change the TV channel, volume, and light based on data of the “watching news” mode generated by the electronic device. In some implementations, the mode generation module 1016 of the electronic device 1004 may additionally generate data of a “watching news after work” mode by mapping the user context for activating the “watching news” mode after work and the state information for watching the news.

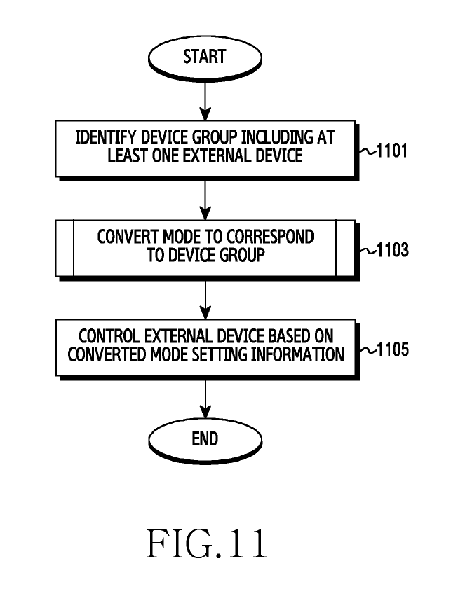

FIG. 11 is a flowchart of an example of a process, according to various embodiments of the present disclosure.

Referring to FIG. 11, in operation 1101, an electronic device (for example, the electronic devices 100, 201, and 301) may identify a device group of at least one external device. For example, the state information analysis module 522 of the mode control module 520 may identify a device group of at least one external device by analyzing the at least one external device present in an area where a user is located or predicted to move. In such instances, the state information analysis module 522 may collect information on the external device from the external device, a server, a hub, or a network. For example, the device group may be associated with a command system and driving conditions for controlling the external device.

In operation 1103, the electronic device may convert a mode so as to correspond to a device group including at least one external device. For example, the mode transition module 524 may select a mode for controlling IoT devices based on the input information provided through the input/output interface 250. The mode transition module 524 may convert the setting information of the selected mode so as to correspond to a device group.

In operation 1105, the electronic device may control at least one external device (for example, an IoT device) included in the device group based on the converted mode setting information.

According to various embodiments of the present disclosure, an electronic device (for example, the electronic devices 100, 201, and 301) may identify a device group of at least one external device (for example, operation 1101). The electronic device may control at least one external device (for example, an IoT device) included in the device group based on at least some of the pre-stored setting information (for example, setting information corresponding to another device group) (for example, operation 1105). In some implementations, the device group may be associated with a command system and driving conditions for controlling the external device. That is, when controlling the external device included in the device group based on the pre-stored setting information, the electronic device may omit the mode conversion operation (for example, operation 1103).

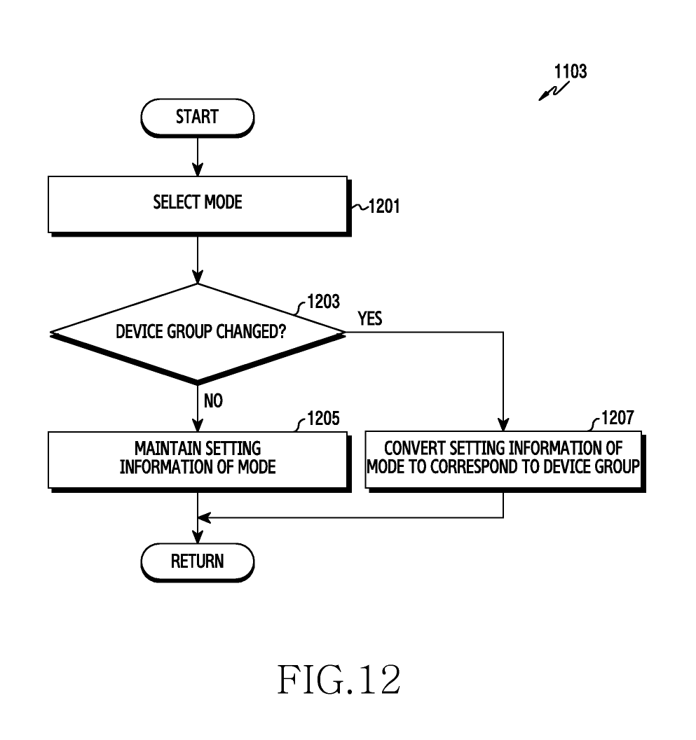

FIG. 12 is a flowchart of an example of a sub-process for performing operation 1103 of the process of FIG. 11, according to various embodiments of the present disclosure.

Referring to FIG. 12, in operation 1201, an electronic device (for example, the electronic devices 100, 201, and 301) may select a mode. For example, when a user context received from the context collection module 512 is changed, the mode transition module 524 may select a mode corresponding to the changed user context. For example, the mode transition module 524 may select a mode based on input information (for example, gestures, voice commands) received through the input/output interface 250.

In operation 1203, the electronic device may detect whether a device group corresponding to the mode is changed. For example, the mode transition module 524 may compare a device group used to generate data for the mode selected in operation 1201 and a device group identified in the operation 1101. The mode transition module 524 may determine that the device group corresponding to the mode is changed when two device groups fail to satisfy a predetermined matching condition as a result of the comparison. In some implementations, the two device groups may fail to satisfy the matching condition when they are not identical.

In operation 1205, when the device group is not changed, the electronic device may maintain data (setting information) of the corresponding mode.

In operation 1207, when the device group corresponding to the mode is changed, the electronic device may convert the setting information of the mode so as to correspond to the device group. For example, the mode transition module 524 may activate a “wake up” mode which sets the volume of the first TV included in the first device group to 10 in a state where the second TV included in the second device group is detected. The mode transition module 524 may convert data of the “wake up” mode so as to include the volume (for example, volume 12) of the second TV having the same sound output as the volume 10 of the first TV in response to detecting the difference of the volume between the first TV and the second TV.

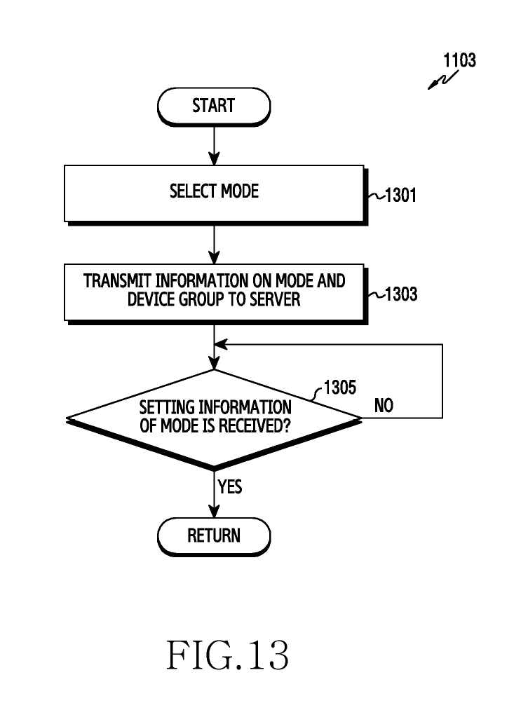

FIG. 13 is a flowchart of an example of a sub-process for performing operation 1103 of the process of FIG. 11, according to various embodiments of the present disclosure.

Referring to FIG. 13, in operation 1301, an electronic device (for example, the electronic devices 100, 201, and 301) may select a mode. For example, the mode transition module 524 may select a mode based on information on the change of user context or user input information (for example, gestures, voice commands).

In operation 1303, the electronic device may transmit information on the mode selected in operation 1301 and information on the device group identified in the operation 1101 to the server. For example, electronic device 200 may transmit identification information on the mode and information on the external device included in the device group to the server (for example, a cloud server).

In operation 1305, the electronic device may check whether the setting information of the mode is received. For example, the electronic device may receive setting information of the corresponding mode from the server in response to the transmission of the mode and information on the device group.

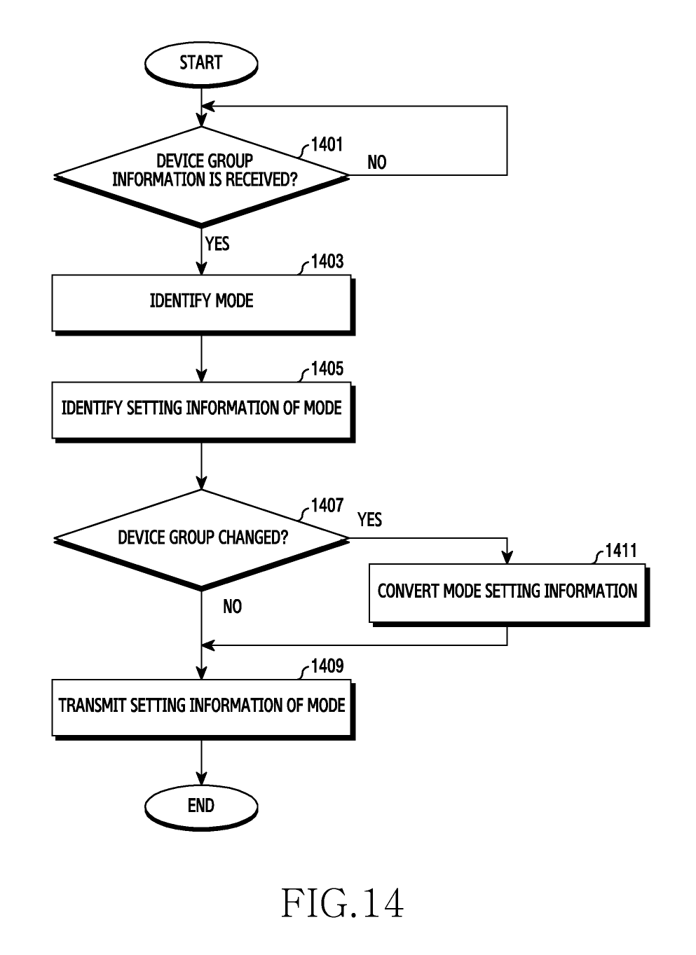

FIG. 14 is a flowchart of an example of a process, according to various embodiments of the present disclosure. In the following, a description will be given of an operation for converting the setting information of the mode by the server in response to the operation of the electronic device of FIG. 13.

Referring to FIG. 14, in operation 1401, the server may check whether the device group information is received from an electronic device (for example, the electronic devices 100, 201, and 301) that identifies a particular device group.

In operation 1403, when receiving the device group information, the server may identify a mode selected by the electronic device. For example, the server may identify mode information received from the electronic device along with device group information.

In operation 1405, the server may identify the setting information of the mode identified in operation 1403. That is, the server may identify the device group of used to generate the setting information of the mode.

In operation 1407, the server may detect whether the device group corresponding to a mode is changed. For example, the server may compare the device group of the mode identified in operation 1405 and the device group identified by the information received at operation 1401. When it is determined that two device groups fail to satisfy a predetermined matching condition, the server may determine that the device group corresponding to the mode is changed. In some implementations, the two device groups may fail to satisfy the matching condition when they are not identical.

In operation 1409, when the device group has not changed, the server may transmit the predetermined data (setting information) for the mode to the electronic device.

In operation 1411, when the device group corresponding to the mode is changed, the server may change the setting information of the mode so as to correspond to the device group received at operation 1401.

In operation 1409, the server may transmit the converted mode setting information in operation 1411 to the electronic device.

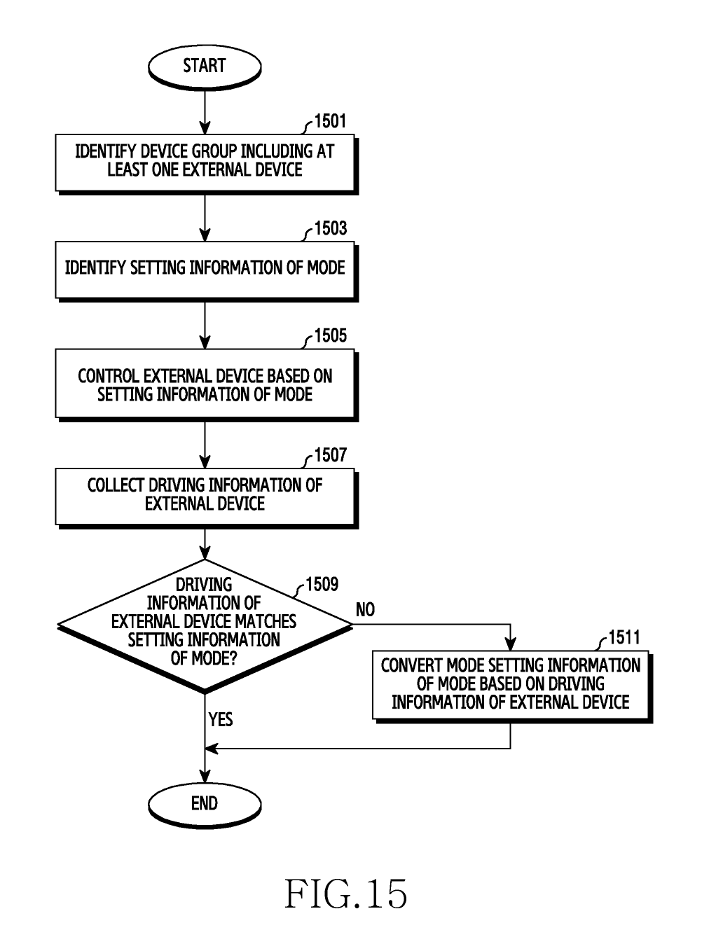

FIG. 15 is a flowchart of an example of a process, according to various embodiments of the present disclosure.

Referring to FIG. 15, in operation 1501, the electronic device (for example, the electronic device 100, 201, 301) may identify a device group of at least one external device. For example, the state information analysis module 522 may identify a device group of at least one external device controllable by the electronic device 200 in an area where the user is located. For example, the state information analysis module 522 may identify a device group of at least one external device controllable by the electronic device 200 in an area where the user is predicted to move. In some implementations, the device group may be associated with a command system and driving conditions for controlling the external device.

In operation 1503, the electronic device may select a mode for controlling the device group. For example, when detecting a user movement to a particular location (e.g., location to which movement was expected to lead) based on the user context, the mode transition module 524 may select a mode corresponding to the location. For example, the mode transition module 524 may select a mode based on the input information (for example, gestures, voice commands) received through the input/output interface 250.

In operation 1505, the electronic device may control at least one external device based on the setting information of the mode selected in operation 1503. For example, the electronic device may detect whether it can support the setting information of the mode based on the capabilities of at least one external device controllable by the electronic device. When it is determined that the setting information of the mode can be supported, the electronic device may control respective external devices so as to correspond to the setting information of the mode.

In operation 1507, the electronic device may collect driving information on the at least one external device. For example, the state information collection module 514 may collect the state information on the at least one external device in accordance with the setting information of the mode.

In operation 1509, the electronic device may detect whether driving information of the external device matches the setting information of the mode. For example, the electronic device may set the volume of the TV included in the device group to 10 based on the setting information of the “watching news” mode in operation 1505. The mode transition module 524 may detect whether a sound output value in a state where the volume of the TV included in the device group is set to 10 matches a sound output value according to the data of the mode.

When the driving information of the external device matches the setting information of the mode, the electronic device may determine that a device group identified in operation 1501 matches (and/or is identical to) the device group of the mode. Accordingly, the electronic device may maintain the setting information of the mode.

In operation 1511, when the driving information of the external device does not match the setting information of the mode, the electronic device may convert the setting information of the mode based on the driving information of the external device. For example, when the sound output of the TV according to the control of the electronic device does not match the sound output value set in the “watching news” mode, the mode transition module 524 may convert the setting information (for example, volume) of the “watching news” mode so as to correspond to the difference between the sound output of the TV according to the control of the electronic device and the sound output set in the “watching news” mode.

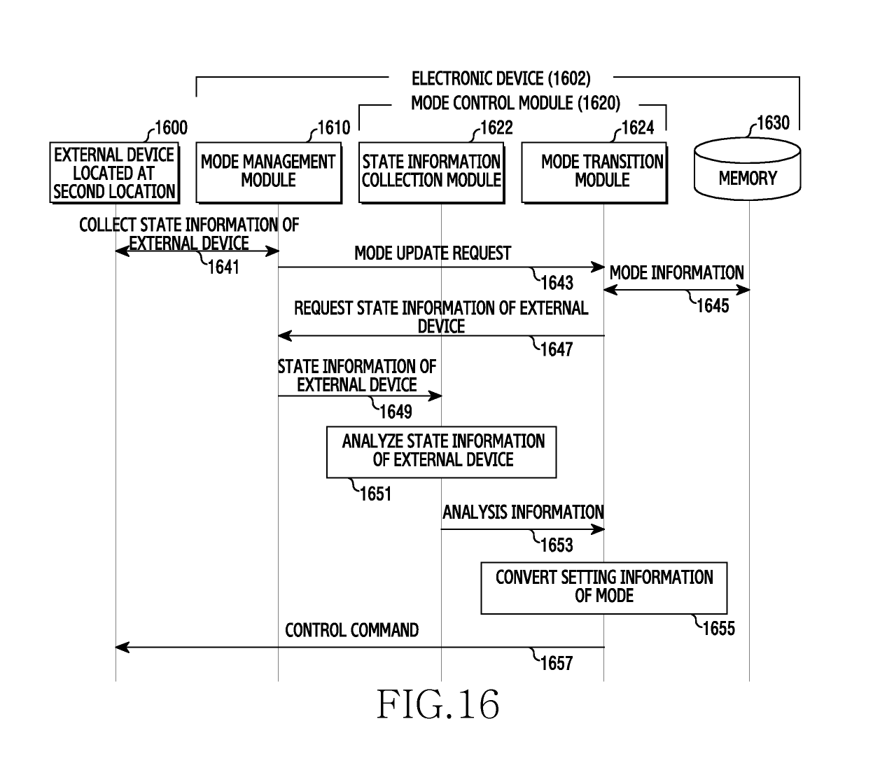

FIG. 16 is a sequence diagram of an example of a process, according to various embodiments of the present disclosure.

Referring to FIG. 16, a mode management module 1610 (e.g., the mode management module 510) of an electronic device 1602 (for example, the electronic devices 100, 201, and 301) may collect the state information on at least one external device (for example, an IoT device) 1600 included in the second area where the electronic device 1602 is located (operation 1641). For example, the mode management module 1610 may collect the state information on at least one external device 1600 (for example, an IoT device) included in the second area where the electronic device 1602 is located, in response to the occurrence of the state information collection event of the external device. In some implementations, the state information collection event may occur periodically and/or repeatedly. Although not been illustrated, the mode management module 1610 may collect the context information of the user 1000.

When the device group of the mode for controlling the external device is changed, the mode management module 1610 may transmit a mode update request signal to a mode transition module 1624 (for example, the mode transition module 524) of a mode control module 1620 (for example, the mode control module 520) (operation 1643).

The mode transition module 1624 may acquire the corresponding mode information from a memory 1630 (for example, the memory 230) in response to the mode update request signal (operation 1645).

The mode transition module 1624 may transmit a signal for requesting the state information of the external device to the mode management module 1610 in response to the mode update request signal (operation 1647).

The mode management module 1610 may transmit the state information of the external device to the state information analysis module 1622 (for example, the state information analysis module 522) of the mode control module 1620 in response to the signal for requesting the state information (operation 1649).

The state information analysis module 1622 may analyze the state information of the external device received from the mode management module 1610 so as to transmit the analyzed state information to the mode transition module 1624 (operations 1651 and 1653). For example, the state information analysis module 1622 may analyze the state information of the external device to identify the type of external device (external device), setting information, manufacturer, etc. The state information analysis module 1622 may detect the difference between the state information of the external device and the setting information of the mode so as to transmit the detected difference to the mode transition module 1624.

The mode transition module 1624 may convert the setting information of the mode based on the analysis information provided from the state information analysis module 1622 (operation 1655). For example, the mode transition module 1624 may convert the setting information of the mode based on the difference between the state information of the external device and the setting information of the mode.

The mode transition module 1624 may control the at least one external device (for example, an IoT device) 1600 included in the second area based on the converted mode setting information (operation 1657).

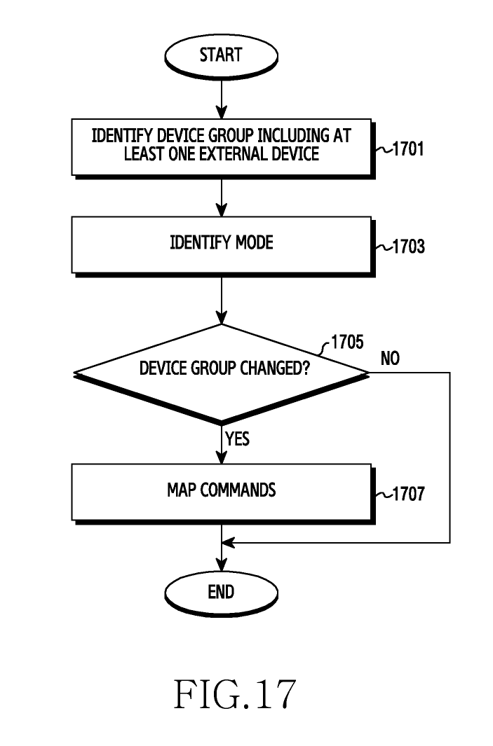

FIG. 17 is a flowchart of an example of a process, according to various embodiments of the present disclosure.

Referring to FIG. 17, in operation 1701, an electronic device (for example, the electronic devices 100, 201, and 301) may identify a device group of at least one external device. For example, the state information analysis module 522 may identify the device group of the at least one external device controllable by the electronic device 200 in an area where the user is located or predicted to move. In some implementations, the device group may be associated with a command system and driving conditions for controlling the external device.

In operation 1703, the electronic device may select a mode for controlling the device group. For example, the mode transition module 524 may select a mode based on the user context information or user input information (for example, gestures, voice commands).

In operation 1705, the electronic device may detect whether the device group corresponding to the mode is changed. For example, the mode transition module 524 may compare a device group used to generate data of the mode selected in operation 1703 and a device group to be controlled by an electronic device (for example, the device group identified in the operation 1701). When it is determined that the two device groups are not identical (or otherwise fail to satisfy a predetermined matching condition) as a result of the comparison, the mode transition module 524 may determine that the device group corresponding to the mode is changed.

In operation 1707, when the device group is changed, the electronic device may map commands of the device group. For example, the processor 220 may match a command structure of the external device used to generate the setting information of the mode and a command structure of the external device to be controlled by the electronic device. For example, the processor 220 may map active commands (for example, gestures and voice commands) of the mode to an external device to be controlled by the electronic device. Specifically, when an active command of the “watching news” mode is “turn on the TV”, the electronic device may map the active command based on the voice command such as “turn on the TV” such that a TV to be controlled is operated by the setting information of the “watching news” mode.

When the device group is not changed, the electronic device may maintain data (setting information) of the corresponding mode.

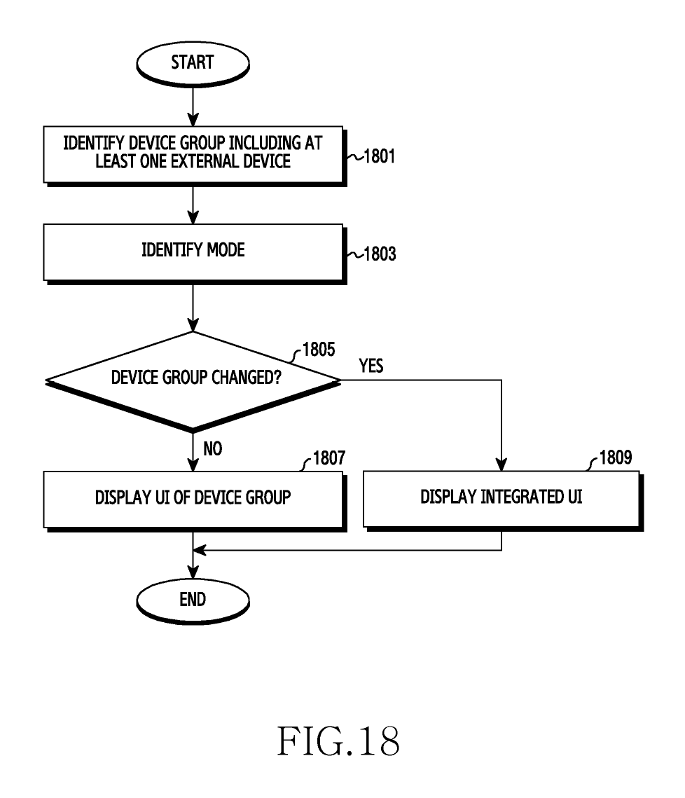

FIG. 18 is a flowchart of an example of a process, according to various embodiments of the present disclosure.

Referring to FIG. 18, in operation 1801, an electronic device (for example, the electronic devices 100, 201, and 301) may identify a device group of at least one external device. For example, the state information analysis module 522 may identify a device group of at least one external device controllable by the electronic device 200. In some implementations, the device group may be associated with a command system and driving conditions for controlling the external device.

In operation 1803, the electronic device may select a mode for controlling the device group. For example, the mode transition module 524 may select a mode based on the user context information or user input information (for example, gestures, voice commands).

In operation 1805, the electronic device may determine whether the device group corresponding to the mode is changed. For example, when a device group of collection information used to generate data for a mode selected in operation 1803 and a device group (for example, a device group identified in operation 1701) controlled by the electronic device are different from each other, the mode transition module 524 may determine that the device group corresponding to the mode is changed.

In operation 1807, when the device group is not changed, the electronic device may display a UI for the corresponding device group.

In operation 1809, when the device group is changed, the electronic device may display an integrated UI. For example, when the user moves to a hotel, the electronic device may match a UI of an external device (for example, a remote controller) detected at the hotel to a UI of an external device (for example, a remote controller) used at home and then display the UI. Specifically, the electronic device may combine the units of the information (brightness, volume) displayed on the remote controller and display the same.

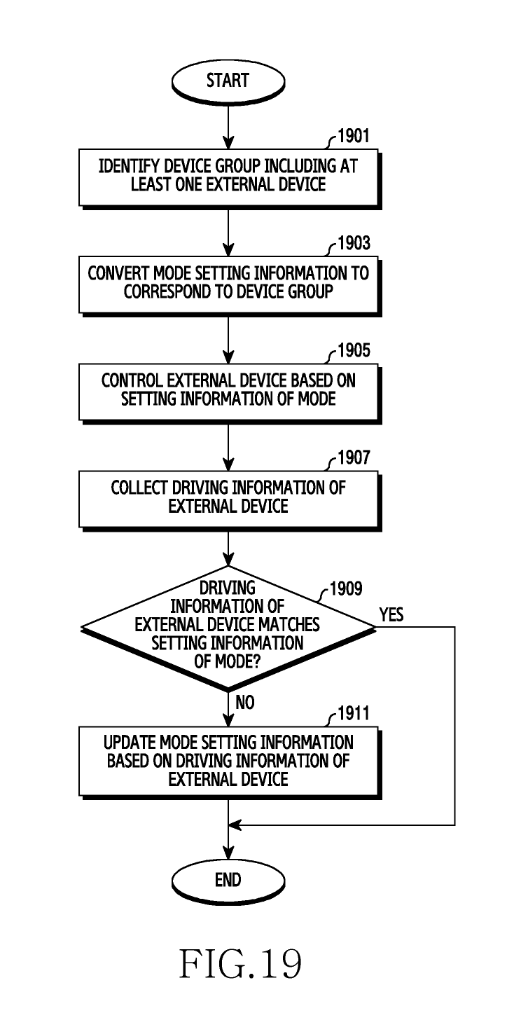

FIG. 19 is a flowchart of an example of a process, according to various embodiments of the present disclosure.

Referring to FIG. 19, in operation 1901, an electronic device (for example, the electronic devices 100, 201, and 301) may identify a device group of at least one external device. For example, the state information analysis module 522 may identify a device group for at least one external device by analyzing the at least one external device present in an area where a user is located or predicted to move. In some implementations, the device group may be associated with a command system and driving conditions for controlling the external device.

In operation 1903, the electronic device may convert the mode to correspond to a device group including at least one external device. For example, the mode transition module 524 may convert the setting information of a particular mode so to correspond to a device group by the operation 1201 to operation 1207 of FIG. 12. For example, the mode transition module 524 may convert the setting information of the mode so as to correspond to the device group by using the server by the operation 1301 to operation 1305 of FIG. 13.

In operation 1905, the electronic device may control at least one external device (for example, an IoT device) based on the converted mode setting information. For example, the processor 220 may control the volume of the TV and the brightness of the light so as to correspond to the mode setting information converted by the mode transition module 524.

In operation 1907, the electronic device may collect drive information on at least one external device controlled based on the converted mode setting information. For example, the drive information on the external device may include environment information (for example, temperature, brightness, sound output, etc.) detected by the electronic device (or a user of the electronic device) according to the driving of the external device.

In operation 1909, the electronic device may detect whether the drive information on the external device matches the setting information of the mode.

In operation 1911, when the driving information of the external device does not match to the setting information of the mode, the electronic device may update the setting information of the mode based on the driving information of the external device. For example, the intensity of light detected through an illuminance sensor may vary depending on a color of light emitted from the light bulb, the type of bulb, and the ambient brightness. Specifically, the brightness of the light bulb at 500 Lux appear higher during the daytime than at night. Accordingly, the electronic device may update the brightness of the light bulb to less than 500 Lux.

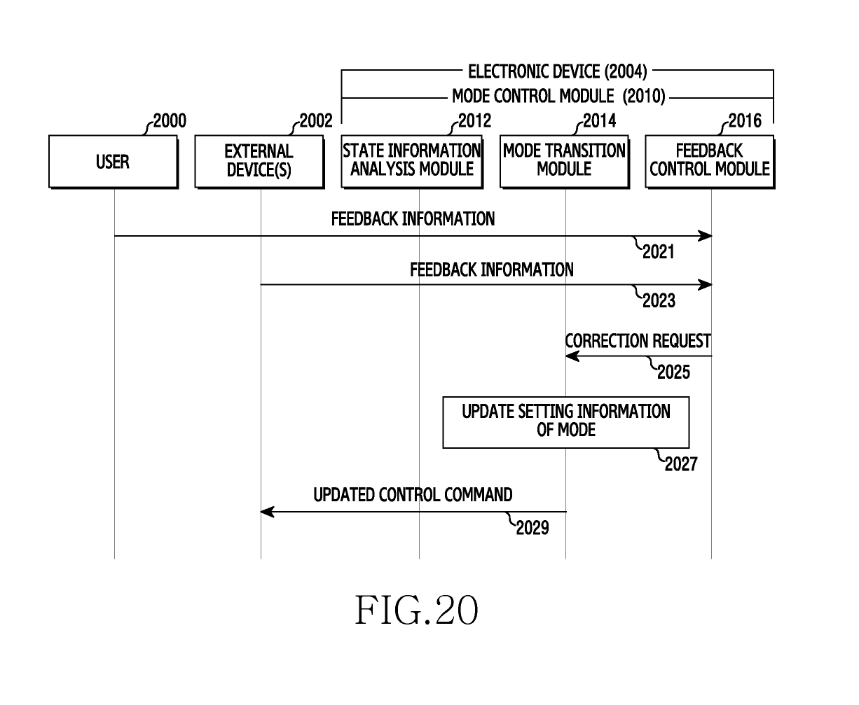

FIG. 20 is a sequence diagram of an example of a process, according to various embodiments of the present disclosure.

Referring to FIG. 20, a feedback control module 2016 (for example, the feedback control module 526) of a mode control module 2010 (for example, the mode control module 520) of an electronic device 2004 (for example, the electronic devices 100, 201, and 301) may receive feedback information from a user 2000 or at least one external device (for example, an IoT device) 2002 (operations 2021 and 2023). For example, the feedback information may include setting change request information input by the user or drive information of an external device 2002.

The feedback control module 2016 may transmit a correction request signal for the mode setting information to a mode transition module 2014 (for example, the mode transition module 524) in response to the reception of the feedback information (operation 2025).

The mode transition module 2014 may update setting information of a mode corresponding to the correction request signal in response to the correction request signal (operation 2027). For example, the mode transition module 2014 may update the setting information of the corresponding mode based on the user's setting change request information in response to the correction request signal. For example, the mode transition module 2014 may update the setting information of the corresponding mode based on the driving information of the external device in response to the correction request signal. Specifically, the electronic device 2004 may control a heating device based on the setting information (for example, 20 degrees) of a “heating” mode. When detecting a temperature lower than a room temperature (e.g., 20 degrees Celsius) preferred by the user, the mode transition module 2014 may update the setting information of the “heating” mode so as to raise the room temperature.

The mode transition module 2014 may control an external device 2002 based on the updated setting information of the mode (operation 2029).

After updating the setting information of the “heating” mode, when the room temperature preferred by the use has not been detected, the electronic device 2004 may update again the setting information of the “heating” mode.

According to various embodiments of the present disclosure, an electronic device may generate and update mode data for controlling at least one external device included in a device group. For example, the electronic device may generate and update mode data based on environment information on the electronic device. Additionally or alternatively, the environment information may generate and update mode data based on user input (e.g. input indicating a user's preference or feedback).

According to various embodiments of the present disclosure, a method for operating an electronic device may include the operations of: identifying a first device group including at least one external device; selecting a mode for controlling the at least one external device; converting setting information of the mode so as to correspond to the first device group, and controlling the at least one external device based on at least some of the converted setting information.

According to various embodiments, the operation of identifying the first device group may include receiving information on the at least one external device.

According to various embodiments, the information on the external device may include at least one among unique identification information, type, a service category, or manufacturer information on the at least one external device.

According to various embodiments, the operation of converting the setting information may include converting the setting information of the mode so as to correspond to the first device group when the setting information of the mode is configured to correspond to a second device group.

According to various embodiments, the first device group may correspond to a first position, and the second device group may correspond to a second position.

According to various embodiments, the first device group and the second device group may include at least one identical external device.

According to various embodiments, the operation of converting the setting information may include generating different setting information for the at least one external device included in the first device group based on at least some of the setting information of the mode.

According to various embodiments, the operation of converting the setting information may include generating the different setting information further based on the environment information on the electronic device.

According to various embodiments, the environment information may include a user preference or feedback on the electronic device.

According to various embodiments, the operation of converting the setting information may include receiving, from the server, different setting information on at least one external device included in the first device group, the different setting information being generated based on at least some of the setting information on the mode.

According to various embodiments of the present disclosure, provided is a computer readable recording medium in which a program is recorded for causing an electronic device to execute operations, the operations comprising: identifying a first device group including at least one external device; selecting a mode for controlling the at least one external device; converting the setting information of the mode so as to correspond to the first device group; and controlling the at least one external device based on at least some of the converted setting information.

An electronic device and an operating method therefor according to various embodiments may update the setting information of various Internet of Things (IoT) devices so as to match user preference environment information, thereby easily controlling various IoT devices in various environments so as to correspond to the user's preferred environment.

The term “module” as used herein may, for example, mean a unit including one of hardware, software, and firmware or a combination of two or more of them. The “module” may be interchangeably used with, for example, the term “unit”, “logic”, “logical block”, “component”, or “circuit”. The “module” may be the smallest unit of an integrated component or a part thereof. The “module” may be the smallest unit that performs one or more functions or a part thereof. The “module” may be mechanically or electronically implemented. For example, the “module” according to the present disclosure may include at least one of an Application-Specific Integrated Circuit (ASIC) chip, a Field-Programmable Gate Arrays (FPGA), and a programmable-logic device for performing operations which has been known or are to be developed hereinafter.

FIGS. 1-20 are provided as an example only. At least some of the operations discussed with respect to these figures can be performed concurrently, performed in different order, and/or altogether omitted. It will be understood that the provision of the examples described herein, as well as clauses phrased as “such as,” “e.g.”, “including”, “in some aspects,” “in some implementations,” and the like should not be interpreted as limiting the claimed subject matter to the specific examples.

The above-described aspects of the present disclosure can be implemented in hardware, firmware or via the execution of software or computer code that can be stored in a recording medium such as a CD-ROM, a Digital Versatile Disc (DVD), a magnetic tape, a RAM, a floppy disk, a hard disk, or a magneto-optical disk or computer code downloaded over a network originally stored on a remote recording medium or a non-transitory machine-readable medium and to be stored on a local recording medium, so that the methods described herein can be rendered via such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein. Any of the functions and steps provided in the Figures may be implemented in hardware, software or a combination of both and may be performed in whole or in part within the programmed instructions of a computer. No claim element herein is to be construed under the provisions of 35 U.S.C. 112, sixth paragraph, unless the element is expressly recited using the phrase “means for”. The terms “unit” or “module” referred to herein is to be understood as comprising hardware such as a processor or microprocessor configured for a certain desired functionality, or a non-transitory medium comprising machine executable code, in accordance with statutory subject matter under 35 U.S.C. §101 and does not constitute software per se.

Moreover, the embodiments disclosed in this specification are suggested for the description and understanding of technical content but do not limit the range of the present disclosure. Accordingly, the range of the present disclosure should be interpreted as including all modifications or various other embodiments based on the technical idea of the present disclosure.

What is claimed is:

1. An electronic device comprising:
a memory; and
at least one processor operatively coupled to the memory, configured to:
identify a first device group including at least a first external device;
select an operating mode;
convert setting information associated with the operating mode so as to corresponds to the first device group; and
control the first external device based on at least some of the converted setting information.

2. The electronic device of claim 1, wherein, when the setting information associated with the operating mode is set to correspond to a second device group, the at least one processor is configured to convert the setting information associated with the operating mode to correspond to the first device group.

3. The electronic device of claim 2, wherein the second device group comprises a second external device for performing the same function as the first external device.

4. The electronic device of claim 2, wherein the second device group includes a second external device of the same type as the first external device.

5. The electronic device of claim 2, wherein:
the first device group corresponds to a first location, and
the second device group corresponds to a second location.

6. The electronic device of claim 5, wherein the at least one processor is configured to identify the first device group on the basis of available resources of the first position.

7. The electronic device of claim 1, wherein the at least one processor is further configured to generate updated setting information for the first external device based on at least some of the setting information.

8. The electronic device of claim 7, further comprising a communication module, wherein the at least one processor is further configured to cause the communication module to transmit the updated setting information to the first external device.

9. The electronic device of claim 7, further comprising one or more sensors operatively coupled to the at least one processor, wherein the updated setting information is generated based on environment information for the electronic device detected by the one or more sensors.

10. The electronic device of claim 9, wherein the environment information comprises a user preference or feedback on the electronic device.

11. A method for use in an electronic device, comprising:
identifying a first device group including at least a first external device;
selecting an operating mode;
converting setting information associated with the operating mode so as to corresponds to the first device group based on the setting information; and
controlling the first external device based on at least some of the converted setting information.

12. The method of claim 11, wherein identifying the first device group comprises receiving information on the first external device.

13. The method of claim 12, wherein the information on the first external device comprises at least one of a unique identifier corresponding to the first external device, an indication of a type of the first external device, an indication of a service category that is associated with the first external device, and an identifier corresponding to a manufacturer of the first external device.

14. The method of claim 11, wherein converting of the setting information comprises converting the setting information of the mode so as to correspond to the first device group when the setting information of the mode is configured to correspond to the second device group.

15. The method of claim 14, wherein:
the first device group corresponds to a first location, and
the second device group corresponds to a second location.

16. The method of claim 14 wherein the first external device and the second external device are of the same type.

17. The method of claim 11, wherein converting the setting information comprises generating updated setting information for the first external device based on at least some of the setting information.

18. The method of claim 17, wherein the updated setting information is generated based on environment information for the electronic device.

19. The method of claim 11, wherein converting of the setting information comprises receiving, from a server, updated setting information on at least one first external device, the updated setting information being generated based on at least some of the setting information of the operating mode.

20. A non-transitory computer readable medium storing one or more processor-executable instructions which when executed by at least one processor cause the at least one processor to execute a method comprising the steps of:
identifying a first device group including at least a first external device;
selecting an operating mode;
converting setting information associated with the operating mode so as to corresponds to the first device group based on the setting information; and
controlling the first external device based on at least some of the converted setting information.
